(19) United States
(12) Patent Application Publication
(10) Pub. No.: US 2017/0091148 A1
(43) Pub. Date: Mar. 30, 2017

(54) METHOD FOR CALCULATING ELLIPTIC CURVE SCALAR MULTIPLICATION

(71) Applicant: Hitachi, Ltd., Tokyo (JP)

(72) Inventor: Masashi TAKAHASHI, Tokyo (JP)

(21) Appl. No.: 15/126,699

(22) PCT Filed: Sep. 26, 2014
(86) PCT No.: PCT/JP2014/075580

§ 371 Date: Sep. 16, 2016

(51) Int. Cl. G06F 17/16; G06F 7/72

(52) U.S. Cl. CPC G06F 17/16; G06F 7/722

(57) ABSTRACT

An elliptic curve scalar multiplication apparatus stores a prime number p and information of a first point, the prime number p defining a field of definition Fₚ, which defines a first curve, which is a Weierstrass form elliptic curve, and expressed as p=p₀+p₁c+ . . . +p₁cⁿ⁻¹, (where c equals 2^{f} and f is an integer equal to or larger than 1 that is units of breaking data into pieces in multiple-precision integer arithmetic executed by the elliptic curve scalar multiplication apparatus), calculates a Montgomery constant k₀, work, and h₁, executes doubling of a second point, which is calculated from the first point, by Montgomery multiplication that uses k₀, work, and h₁, adds a third point and fourth point, which are calculated from the first point, by Montgomery multiplication that uses k₀, work, and h₁; and calculates a scalar multiple of the first point, based on a result of the doubling and the addition.

### BACKGROUND OF THE INVENTION

The present invention relates to an elliptic curve scalar multiplication method.

ECDSA signature is known as a digital signature method that uses a discrete logarithm problem on an elliptic curve. This signature method is implemented with the use of addition or scalar multiplication on an elliptic curve (see, for example, Shay Gueron and Vlad Krasnov: Fast Prime Field Elliptic Curve Cryptography with 256 Bit Primes). Scalar multiplication on an elliptic curve, in particular, affects the speed of signature processing greatly, and therefore has high speed processing as an important object. Weierstrass form elliptic curves are known as elliptic curves suitable for ECDSA signature (see Shay Gueron and Vlad Krasnov: Fast Prime Field Elliptic Curve Cryptography with 256 Bit Primes).

A Weierstrass form elliptic curve disclosed in SEC 1: Elliptic Curve Cryptography (Sep. 20, 2000 Version 1.0) is described first. A Weierstrass form elliptic curve is a curve expressed by y²=x³+ax+b(4a²−27b³≠0, a,b∈ Fₚ) when the field of definition is Fₚ. A point on the curve can be expressed as a pair (x,y) of x,y∈ Fₚ that satisfies the equation of the curve. The prime field Fₚ is a set made up of integers x that satisfy 0≦x<p with respect to a prime number p, and calculation on Fₚ is four arithmetic operations, modulo p.

The following is a formula for an addition of two points on the Weierstrass form elliptic curve, P=(x₁,y₁) and Q=(x₂,y₂):

Input: two points on the Weierstrass form elliptic curve, P=(x₁,y₁) and Q=(x₂,y₂)

Output: R=P+Q=(x₃,y₃)

Processing steps:

(1) Calculate λ←(y₂−y₁)/(x₂−x₁).

(2) Calculate x₃←λ²−x₁−x₂.

(3) Calculate y₃−λ(x₁−x₃)−y₁.

(4) R←(x₃,y₃)

The point P=(x₁,y₁) can be doubled by substituting P for Q (P=Q) in the addition formula given above. The following is the addition formula given above that is specialized for the doubling:

Input: a point P on the elliptic curve, P=(x₁,y₁)

Output: R←2P=(x₃,y₃)

Processing steps:

(1) Calculate λ=(3x₁²+a)/2x₁.

(2) Calculate x₃=λ²−2x₁−x₂.

(3) Calculate y₃=λ(x₁−x₃)−y₁.

(4) R←(x₃,y₃)

The affine coordinate system described above uses division in addition and doubling both. Division requires a longer processing time than multiplication does. A Jacobian coordinate system in which division is avoided in order to accomplish high speed processing is therefore used. Jacobian coordinates are expressed as (X,Y,Z), and converted into affine coordinates by calculating (x,y)=(X/Z²,Y/Z³).

An algorithm for addition on the elliptic curve that does not use division is described next.

Elliptic curve addition

Input: P_{J}=(X₁:Y₁:Z₁), Q_{J}=(X₂:Y₂:Z₂)

Output: R_{J}=(X₃:Y₃:Z₃)=P_{J}+Q_{J}=(X₁:Y₁:Z₁)+(X₂:Y₂:Z₂)

Processing steps:

(1) Calculate U₁←X₁Z₂² and U₂←X₂Z₁².

(2) Calculate S₁←Y₁Z₂³ and S₂←Y₂Z₁³.

(3) Calculate H←U₂−U₁ and R←S₂−S₁.

(4) Calculate X₃←R²−H³−2U₁H².

(5) Calculate Y₃←R(U₁H²−X₃)−S₁H³.

(6) Calculate Z₃←HZ₁Z₂.

(7) Output R_{J}←(X₃:Y₃:Z₃) as the calculation result.

An algorithm for doubling on the elliptic curve that does not use division is described next.

Elliptic curve doubling

Input: P_{J}=(X₁:Y₁:Z₁)

Output: R_{J}=(X₃:Y₃:Z₃)=2P_{J}=2(X₁:Y₁:Z₁)

Processing steps:

(1) Calculate S←4X₁Y₁².

(2) Calculate H←Z₁² and M=3(X₁+H)(X₁−H) when a=−3 is true, and calculate M←3X₁²+aZ₁² otherwise.

(3) Calculate X₃←M²−2S.

(4) Calculate Y₃←M(S−X₃)−8Y₁⁴.

(5) Calculate Z₃←2Y₁Z₁.

(6) Output R_{J}←(X₃:Y₃:Z₃) as the calculation result.

A set made up of all points on the Weierstrass form elliptic curve takes, in the case of addition, the structure of an additive group that has o as an identity element. An inverse element −P of the point P=(x₁,y₁) which satisfies P+(−P)=o is defined as −P=(x₁,−y₁). An arithmetic that uses the point P on the Weierstrass form elliptic curve and the positive integer l to obtain a one-time addition lP by adding P once is called scalar multiplication. In the case where a result qP of scalar multiplication in which the point P on the Weierstrass form elliptic curve is added q times is an identity element o, the positive integer q is called the order of the point P.

A method of calculating a scalar multiple by combining addition and doubling on the Weierstrass form elliptic curve is described next.

Input: the point P on the Weierstrass form elliptic curve, the positive integer l (0<l<q)

Output: Q=lP

Processing steps:

(1) The integer l is expanded by binary expansion into l=l₀+l₁×2+ . . . +lₜ₋₁×2^{t-1} (lₜ₋₁=1).

(2) Put P_{J} as P_{J}=(X₁:Y₁:Z₁)←(x₁:y₁:1).

(3) Put Q_{J} as Q_{J}←P_{J}.

(4) Put i as i←t−2.

(5) Repeat the following processing until i=0 is reached:
(5.1) Calculate Q_{J}←2Q_{J}.
(5.2) Calculate Q_{J}←Q_{J}+P_{J} when lᵢ=1 is true.
(5.3) Calculate i←i−1.

(6) Calculate Q=lP=(x₃,y₃)←(X₃/Z₃²,Y₃/Z₃³) for scalar multiplication result Q_{J}=(X₃:Y₃:Z₃), and output the result of the calculation.

ECDSA signature using a Weierstrass form elliptic curve that is based on ECDSA signature disclosed in SEC 1: Elliptic Curve Cryptography (Sep. 20, 2000 Version 1.0) is described next. In the following, an elliptic curve is a Weierstrass form elliptic curve unless otherwise noted.

ECDSA signature includes the following three processing procedures:

1) Key pair generation: a key pair used to generate and verify an ECDSA signature is generated. Of the key pair, a private key, which is used for signature generation, is stored securely by a person who generates the signature in a manner that prevents leakage to the outside, and a public key, which is used for signature verification, is published to the outside.

2) Signature generation: a digital signature is generated for a plain text to be signed, with the use of the private key.

3) Signature verification: signature verification is conducted with the use of the public key, the signed plain text, and the digital signature.

1) Key Generation:

Input: an elliptic curve y²=x³+ax+b (4a²₋₂₇b³≠0, a,b∈ Fₚ), the field of definition Fₚ, a base point G on the elliptic curve G=(x_{g},y_{g}), the order q (a prime number) of the base point G

Output: a private key dₚᵣᵢ, a public key Q_{pub}=(x_{q},y_{q})

Processing steps:

(1) Generate, at random, an integer dₚᵣᵢ that satisfies 0<dₚᵣᵢ<q, and use the generated integer as the private key.

(2) Calculate a scalar multiple on the elliptic curve, Q_{pub}←dₚᵣᵢG=(x_{q},y_{q}), and use the calculation result as the public key.

(3) Output the key pair (dₚᵣᵢ,Q_{pub})

2) Signature Generation:

Input: the elliptic curve y²=x³+ax+b (4a²−27b³≠0, a,b∈ Fₚ), the field of definition Fₚ, the base point G on the elliptic curve G=(x_{g},y_{g}), the order q (a prime number) of the base point G, data M to be signed, the private key dₚᵣᵢ

Output: a signature (r,s)

Processing steps:

(1) Generate, at random, an integer aᵣ that satisfies 0<aᵣ<q.

(2) Calculate a scalar multiple on the elliptic curve, Q_{R}←aᵣG=(xᵣ,yᵣ).

(3) Calculate r←xᵣ mod q.

(4) Calculate e←H(M) by using a hash function H.

(5) Calculate s←aᵣ⁻¹(e+rdₚᵣᵢ) mod q.

(6) Output (r, s) as a signature of the data M to be signed.

3) Signature Verification:

Input: the elliptic curve y²=x³+ax+b (4a²−27b³≠0, a,b∈ Fₚ), the field of definition Fₚ, the base point G of the elliptic curve G=(x_{g},y_{g}), the public key Q_{pub}=(x_{q}, y_{q}), the order q (a prime number) of the base point G and the public key Q_{pub}, the signature verification target data M, the signature (r, s)

Output: “true” (successfully verified) or “false” (unsuccessfully verified)

Processing steps:

(1) Calculate e←H(M) by using the hash function H.

(2) Calculate e′←s⁻¹e mod q.

(3) Calculate r′←s⁻¹r mod q.

(4) Calculate G′←e′G.

(5) Calculate Q′←r′Q.

(6) Calculate R′←(xᵣ′,yᵣ′)=G′+Q′.

(7) Output “true” when xᵣ′ mod q=r is established, and output “false” otherwise.

Four arithmetic operations of a multiple-precision integer that is used in calculation on an elliptic curve are described next based on a multiple-precision integer arithmetic that is disclosed in Chapter 14 of Alfred J. Menezes, Paul C. van Oorschot, Scott A. Vanstone: Handbook of Applied Cryptography (Discrete Mathematics and Its Applications), CRC Press, 1996. The four arithmetic operations of a multiple-precision integer are implemented by breaking the multiple-precision integer into f-bit data and combining calculations in units of f bits.

1) Addition Algorithm:

Input: x=x₀+x₁c+ . . . +xₙcⁿ⁻¹, y=y₀+y₁c+ . . . +yₜc^{t-1}(c=2^{f}, f≧1, y≦x, 1≦t≦n)

Output: z=x+y

Processing steps:

(1) Put cₐ←0.

(2) Repeat the following processing until i=0 reaches i=t:
(2.1) Calculate zᵢ←xᵢ+yᵢ+cₐ mod c.
(2.2) Put cₐ←0 when zᵢ<c is true, and put cₐ←1 otherwise.

(3) Repeat the following processing until i=t+1 reaches i=n:
(3.1) Calculate zᵢ←xᵢ+cₐ mod c.
(3.2) Put cₐ←0 when zᵢ<c is true, and put cₐ←1 otherwise.

(4) Put zₙ₊₁←cₐ.

(5) Put z=z₀+zx₁c+ . . . +zₙ₊₁cⁿ, and output z as the calculation result.

2) Subtraction Algorithm:

Input: x=x₀+x₁c+ . . . +xₙcₙ₋₁, y=y₀+y₁c+ . . . +yₜc^{t-1}, yᵢ=0(t<i≦n) (c=2^{f}, f≦1, y≦x, 1≦t≦n)

Output: z=x−y=z₀+z₁c+ . . . +zₙcⁿ⁻¹

Processing steps:

(1) Put cₐ←0.

(2) Repeat the following processing until i=0 reaches i=n:
(2.1) Calculate zᵢ←xᵢ−yᵢ+cₐ mod c.
(2.2) Put cₐ←0 when zᵢ<b is true, and put cₐ←−1 otherwise.

(3) Put z←x−y=z₀+z₁c+ . . . +zₙcⁿ⁻¹.

3) Multiplication Algorithm:

Input: x=x₀+x₁c+ . . . +xₙcⁿ⁻¹, y=y₀+y₁c+ . . . +yₜc^{t-1} (c=2^{f}, f≧1, y≦x, 1≦t≦n)

Output: z=x×y=z₀+z₁c+ . . . +zₙ₊ₜ₊₁cⁿ⁺¹

Processing steps:

(1) Repeat the following processing until i=0 reaches i=n+t+1:
(1.1) Put zᵢ←0.

(2) Repeat the following processing until i=0 reaches i=t:
(2.1) Put cₐ←0.
(2.2) Repeat the following processing until j=0 reaches j=n:
   (2.2.1) Calculate zᵢ₊ⱼ+xᵢyᵢ+cₐ, put the most significant f bits as h, put the least significant f bits as l, and put zᵢ₊ⱼ←l and cₐ←h.
(2.3) Put zᵢ₊ₙ₊₁←u.

(3) Put zᵢ₊ₙ₊₁←cₐ.

(4) Put z←z₀+z₁c+ . . . +zₙ₊ₜ₊₁c^{n+t}, and output z as the calculation result.

4) Modulo Operation Algorithm:

Input: x=x₀+x₁c+ . . . +xₙcⁿ⁻¹,y=y₀+y₁c+ . . . +yₜc^{t-1} (c=2^{f}, f≧1, 0<y≦x, yₜ≠0, 1≦t≦n)

Output: quotient q=q₀+q₁c+ . . . +qₙ₋ₜcₙ₋ₜ₋₁, remainder r=r₀+r₁c+ . . . +rₜc^{t-1} (x=qy+r, r<y)

Processing Steps:

(1) Repeat the following processing until j=0 reaches j=n−t:
(1.1) Put qⱼ←0.

(2) Repeat the following processing as long as x≧yc^{n-t} is satisfied:
(2.1) Put qₙ₋ₜ←qₙ₋ₜ+1 and x←x−yc^{n-t}.

(3) Repeat the following processing until i=n reaches i=t+1:
(3.1) Put qᵢ₋ₜ₋₁←c−1 when x=y is true, and put qᵢ₋ₜ₋₁←[(xᵢc+xᵢ₋₁)/yₜ] otherwise. [x] represents the maximum integer equal to or less than a real number x.
(3.2) Repeat the following processing as long as (qᵢ₋ₜ₋₁(xᵢc+xᵢ₋₁)>xᵢc²+xᵢ₋₁c+xᵢ₋₂) is satisfied:
   (3.2.1) Put qᵢ₋ₜ₋₁←qᵢ₋ₜ₋₁−1.
(3.3) Put x←x−qᵢ₋ₜ₋₁yc^{i-t-1}.
(3.4) Put x←x+yc^{i-t-1} when x<0 is true, and put qᵢ₋ₜ₋₁←qᵢ₋ₜ₋₁−1 otherwise.

(4) Put r←x.

(5) Output q and r as the calculation result.

Arithmetic operations on F_{P} that are used in calculation on an elliptic curve are described next based on algorithms that are disclosed in Chapter 14 of Alfred J. Menezes, Paul C. van Oorschot, Scott A. Vanstone: Handbook of Applied Cryptography (Discrete Mathematics and Its Applications), CRC Press, 1996. Addition, subtraction, multiplication, and division that are used in the disclosed algorithms use the addition, subtraction, multiplication, and division of a multiple-precision integer that are disclosed in Chapter 14 of Alfred J. Menezes, Paul C. van Oorschot, Scott A. Vanstone: Handbook of Applied Cryptography (Discrete Mathematics and Its Applications), CRC Press, 1996.

1) Algorithm for Addition on F_{P}

Input: x, y<p

Output: z=x+y mod p

Processing steps:

(1) Calculate z←x+y.

(2) Output z←z−p as the calculation result when z>p is true, and output z as the calculation result otherwise.

2) Algorithm for Subtraction on F_{P}

Input: x,y<p

Output: z=x−y mod p

Processing steps:

(1) When x=y is true, put z←0 and output z as the calculation result.

(2) When x>y is true, calculate z←x−y and output z as the calculation result.

(3) When y>x is true, calculate z←p−(y−x) and output z as the calculation result.

3) Algorithm for Multiplication on F_{P}

Input: x, y<p

Output: z=xy mod p

Processing steps:

(1) Calculate z←xy.

(2) Calculate x/y using the division algorithm, and the remainder is given as r.

(3) Put z←r and output z as the calculation result.

When the described algorithm for multiplication on F_{P} is used and xy>p is satisfied, division that causes a heavy processing load needs to be performed. Montgomery arithmetic is known as a method of speeding up processing by avoiding this division heavy in processing load. Montgomery arithmetic is a method of processing, at high speed, calculation on the prime field F_{P}, and uses R, which satisfies p<R and R=2^{l} (l is a positive integer), to perform conversion xₘ=xR mod p on an element x on the prime field F_{P}. Four arithmetic operations are each performed on the result of the conversion to obtain a calculation result xₘ. Lastly, x=xₘR⁻¹ mod p is calculated, thereby obtaining a result x of calculation on the prime field F_{P}. Addition and subtraction in Montgomery arithmetic can use the addition and subtraction on F_{P} of the related art. Multiplication in Montgomery arithmetic, on the other hand, requires an algorithm for Montgomery multiplication because an extra R is multiplied and R⁻¹ therefore needs to be multiplied.

Montgomery multiplication disclosed in Shay Gueron and Vlad Krasnov: Fast Prime Field Elliptic Curve Cryptography with 256 Bit Primes is described next.

Montgomery Multiplication

Input: a prime number p that satisfies 2<p<2^{l}, a positive integer l, 0≦a,b<p, an integer f(f≧1) that satisfies l=fn

Output: ab2⁻¹ mod p

Pre-calculation: k₀←−p⁻¹ mod 2^{f}

Processing steps:

(1) T←ab

(2) Repeat the following processing until i=0 reaches i=n:
(2.1) T₁←T mod 2^{f}
(2.2) Y←T₁k₀ mod 2^{f}
(2.3) T₂←Yp
(2.4) T₃←(T+T₂)
(2.5) T←T₃/2^{f}

(3) X←T−p when T≧p is true, T←X otherwise.

(4) Output X as the calculation result.

Multiplication is used in T←T₃/2^{s} in (2.5) of the algorithm described above. This calculation can be made by shifting T₃ by s bits to the right because the least significant s bits of T₃ are guaranteed to be 0. The multiplication is thus accomplished without needing division. Addition and subtraction in a Montgomery area that is an area after conversion by xₘ=xR mod p can be made by using the algorithms for addition and subtraction on F_{P}.

An elliptic curve disclosed in Mathematical routines for the NIST prime elliptic curves (Apr. 5, 2010), Curve P-256, is described next. Curve P-256 is an elliptic curve y²=x³+ax+b on the prime field Fₚ defined with the use of a prime number NIST P-256 p₂₅₆=2²⁵⁶−2²²⁴+2¹⁹²+2⁹⁶−1, and satisfies a=p₂₅₆−3 and b=4105836372515214212932612978004726840911444101599372555483 5256314039467401291 (decimal). The prime number p₂₅₆ broken into units of 64 bits is expressed as p₂₅₆=ffffffff00000001 0000000000000000 00000000ffffffff ffffffffffffffff (hexadecimal).

When a multiple-precision integer is broken into units of 64 bits and calculated in Montgomery multiplication that uses the prime number p₂₅₆, f equals 64 and k₀ is calculated as 1 by pre-calculation k₀=−p₂₅₆⁻¹ mod 2⁶⁴. In the case where the least significant f bits of the prime number p are all 1, k₀ is calculated as 1 by k₀=−p⁻¹ mod 2^{f}. An algorithm that speeds up Montgomery multiplication by using this property is disclosed in SEC 1: Elliptic Curve Cryptography (Sep. 20, 2000 Version 1.0).

Montgomery multiplication when k₀=1 disclosed in Mathematical routines for the NIST prime elliptic curves (Apr. 5, 2010) is described next.

Montgomery Multiplication

Input: a prime number p that satisfies 2<p<2^{l} and −p mod 2^{f}=1, a positive integer l, 0≦a,b<p, an integer f (f≧1) that satisfies l=fn

Output: ab2⁻¹ mod p

Processing steps:

(1) T←ab

(2) Repeat the following processing until i=0 reaches i=n:
(2.1) T₁←T mod 2^{f}
(2.2) T₂←T₁p
(2.3) T₃←(T+T₂)
(2.4) T←T3/2^{f}

(3) X←T−p when T≧p is true, T←X otherwise.

(4) Output X as the calculation result.

Montgomery multiplication that is made in units of f bits when pre-calculation is necessary is described next based on Cetin Kaya Koc, Tolga Acar and Burton S. Kaliski Jr. Analyzing and Comparing Montgomery Multiplication Algorithms IEEE Micro, 16(3):26-33, June 1996.

Input: x=x₀+x₁c+ . . . +xₙcⁿ⁻¹, y=y₀+y₁c+ . . . +yₙcⁿ⁻¹, a prime number p=p₀+p₁c+ . . . +pₙcⁿ⁻¹ (c=2^{f}, f≧1, x<p, y<p, l≦n)

Output: z=xy2⁻¹ mod p=z₀+z₁c+ . . . +zₙ₊₁cⁿ

Pre-calculation: k₀=−p₀⁻¹ mod c

Processing steps:

(1) Put z←0.

(2) Repeat the following processing until i=0 reaches i=n:
(2.1) Calculate z₀+x₀yᵢ, put the least significant f bits as l, and put the most significant f bits as h.
(2.2) Calculate z₁+z₂c+ . . . +zₙ₊₂cⁿ←z₁+z₂c+ . . . +zₙ₊₁cⁿ⁻¹+h.
(2.3) Calculate work←lk₀ mod c.
(2.4) Calculate l+p₀work, put the least significant f bits as l, and put the most significant f bits as h.
(2.5) Repeat the following processing until j=l reaches j=n:
   (2.5.1) Calculate zⱼ+xⱼyᵢ+h, put the least significant f bits as l, and put the most significant f bits as h.
   (2.5.2) Calculate zⱼ₊₁+zⱼ₊₂c+ . . . +zₙ₊₂c^{n-j}←zⱼ₊₁+zⱼ₊₂c+ . . . +zₙ₊₁c^{n-j-1}+h.
   (2.5.3) Calculate l+pⱼwork, put the least significant f bits as l, and put the most significant f bits as h.
   (2.5.4) Put zⱼ₋₁←l.
(3) Calculate zₙ₊₁+h, put the least significant f bits as l, and put the most significant f bits as h.

(4) Put zₙ←l.

(5) Calculate zₙ₊₁←zₙ₊₂+h.

(6) Put zₙ₊₂←0.

(7) Put z=z₀+z₁c+ . . . +zₙcⁿ⁻¹+zₙ₊₁cⁿ.

(8) When z≧p is true, calculate z←z−p and output z as the calculation result.

### SUMMARY OF THE INVENTION

Processing of scalar multiplication on an elliptic curve is indispensable in ECDSA signature. However, it is a known fact that scalar multiplication processing is heavy in load and therefore affects processing performance greatly. It is also known that the processing performance of scalar multiplication depends on the number of times addition, subtraction, multiplication, squaring, and multiplication by a constant number on a field of definition on an elliptic curve are performed, and Montgomery arithmetic is known as a method of speeding up the listed arithmetics.

When z←xyR⁻¹ mod p is calculated by using Montgomery multiplication of x=x₀+x₁c+ . . . +xₙcⁿ⁻¹, y=y₀+y₁c+ . . . +yₙcⁿ⁻¹, a prime number p=p₀+p₁c+ . . . +pₙcⁿ⁻¹ (c=2^{f}, x<p, y<p, l≦n), and R=2^{fn}, f-bit multiplication, which greatly affects processing performance, is executed 2n²+n times.

The art disclosed in SEC 1: Elliptic Curve Cryptography (Sep. 20, 2000 Version 1.0) speeds up Montgomery multiplication by reducing multiplication in units of 64 bits, which is heavy in per-processing load, per loop, when the least significant 64 bits are 2⁶⁴−1 (=0xffffffffffffffff) as in the NIST prime number P-256 p₂₅₆=2²⁵⁶−2²²⁴+2¹⁹²+2⁹⁶−1 and the unit of processing is 64 bits. When this method is used to calculate z←xyR⁻¹ mod p, the number of times f-bit multiplication, which greatly affects processing performance, is executed is 2n², n times less than when the method is not used.

When this speed-up method is applied to, for example, Curve P-384 disclosed in Mathematical routines for the NIST prime elliptic curves (Apr. 5, 2010), the least significant 64 bits of the NIST prime number p₃₈₄=2³⁸⁴−2¹²⁸−2⁹⁶+2³²−1 used to define Curve P-384 are 2³²−1 (=0xffffffff). This generates the need to conduct processing in units of 32 bits when processing in units of 64 bits is executable. Executing 64-bit multiplication once is equivalent to executing 32-bit multiplication four times, and the speed performance is accordingly about four times lower than in a configuration that uses 64-bit multiplication.

The one aspect of the present invention has been made in view of the problem described above, and aims for even faster processing in Montgomery multiplication of data broken into units of f bits, by optimizing calculation when the least significant f bits p₀ of a prime number p that defines a prime field are 2^{g}−1 or 2^{g}+1 (f/2≦g<f), and by replacing one session of f-bit multiplication per loop with addition and shift operation, which are lighter in processing load. This speeds up Montgomery multiplication even when the least significant 64 bits are 2³²−1 (=0xffffffff) as in the case of, for example, NIST P-384, and reduces the number of times f-bit multiplication is performed from 2n²+n to 2n² by n times, thus accomplishing high speed multiplication processing.

The present invention has, for example, the following configuration to solve above-mentioned problem. An elliptic curve scalar multiplication method by which an elliptic curve scalar multiplication apparatus is configured to execute scalar multiplication of a first point on a first curve, which is a Weierstrass form elliptic curve, the elliptic curve scalar multiplication apparatus being configured to store a prime number p and information of the first point, the prime number p defining a field of definition Fₚ, which defines the first curve, and being expressed as p=p₀+p₁c+ . . . +pₙcⁿ⁻¹, (where c equals 2^{f} and f is an integer equal to or larger than 1 that is units of breaking data into pieces in multiple-precision integer arithmetic executed by the elliptic curve scalar multiplication apparatus), the elliptic curve scalar multiplication method comprising: a first step of calculating, by the elliptic curve scalar multiplication apparatus, a Montgomery constant k₀, which is used for Montgomery multiplication of data x and data y, which are multiple-precision integers in units of f bits and expressed as x=x₀+x₁c+ . . . +xₙcⁿ⁻¹ and y=y₀+y₁c+ . . . +yₙcⁿ⁻¹ (c=2^{f}, f≧1, x<p, y<p, l≦n), by the following processing (a1) through processing (a8): (a1) determining whether or not p₀=2^{f}−1 is true, and proceeding to the processing (a2) when it is determined that p₀=2^{f}−1 is true, and to the processing (a3) when it is determined that p₀=2^{f}−1 is not true; (a2) putting k₀←1, and proceeding to the processing (a8); (a3) determining, for an integer that satisfies f/2≦g<f, whether or not p₀=2^{g}−1 is true, and proceeding to the processing (a4) when it is determined that p₀=2^{g}−1 is true, and to the processing (a5) when it is determined that p₀=2^{g}−1 is not true; (a4) putting k₀←2^{g}+1, and proceeding to the processing (a8); (a5) determining, for an integer that satisfies f/2≦g<f, whether or not p₀=2^{g}+1 is true, and proceeding to the processing (a6) when it is determined that p₀=2^{g}+1 is true, and to the processing (a7) when it is determined that p₀=2^{g}+1 is not true; (a6) putting k₀←2^{g}−1, and proceeding to the processing (a8); (a7) calculating k₀←−p⁻¹ mod 2^{f}, and proceeding to the processing (a8); and (a8) using the k₀ as a calculation result; a second step of calculating, by the elliptic curve scalar multiplication apparatus, work and h₁ by the following processing (b1) through processing (b11): (b1) determining whether or not k₀=1 is true, and proceeding to the processing (b2) when it is determined that k₀=1 is true, and to the processing (b4) when it is determined that k₀=1 is not true; (b2) putting work←l₀ (where l₀ is a least significant f bits value of x₀y₀); (b3) putting h₁←work, and proceeding to the processing (b11); (b4) calculating work←l₀k₀ mod c; (b5) determining whether or not k₀=2^{g}+1 is true, and proceeding to the processing (b6) when it is determined that k₀=2^{g}+1 is true, and to the processing (b7) when it is determined that k₀=2^{g}+1 is not true; (b6) calculating h₁←(work+(l₀>>g))>>(f−g); (b7) determining whether or not k₀=2^{g}−1 is true, and proceeding to the processing (b8) when it is determined that k₀=2^{g}−1 is true, and to the processing (b10) when it is determined that k₀=2^{g}−1 is not true; (b8) calculating h₁←(work+(l₀>>g))>>(f−g); (b9) determining whether or not h₁≠0 is true, calculating h₁←h₁+1 and proceeding to the processing (b11) when it is determined that h₁≠0 is true, and proceeding to the processing (b11) without making the calculation when it is determined that h₁=0 is true; (b10) calculating l₀+p₀work, putting most significant f bits of the calculated l₀+p₀work as h₁, and proceeding to the processing (b11); and (b11) using the work and the h₁ as a calculation result; a third step of executing, by the elliptic curve scalar multiplication apparatus, doubling of a second point, which is calculated from the first point, by Montgomery multiplication that uses the calculated Montgomery constant k₀, the calculated work, and the calculated h₁; a fourth step of adding, by the elliptic curve scalar multiplication apparatus, a third point and a fourth point, which are calculated from the first point, by Montgomery multiplication that uses the calculated Montgomery constant k₀, the calculated work, and the calculated h₁; and a fifth step of calculating, by the elliptic curve scalar multiplication apparatus, a scalar multiple of the first point, based on a result of the doubling of the second point and on a result of the addition of the third point and the fourth point.

According to the one aspect of the present invention, high speed processing is accomplished by reducing the number of times multiplication in units of f bits needs to be performed per one session of Montgomery multiplication from 2n²+n to 2n². Even faster public-key encryption and digital signature are thus realized.

### BRIEF DESCRIPTIONS OF DRAWINGS

The present invention can be appreciated by the description which follows in conjunction with the following figures, wherein:

FIG. 1A is a diagram for illustrating a configuration example of an elliptic curve scalar multiplication apparatus according to an embodiment mode;

FIG. 1B is a diagram for illustrating a hardware configuration example of an information processing apparatus;

FIG. 2 is a diagram for illustrating a configuration example of an elliptic curve scalar multiplication unit;

FIG. 3 is a flow chart for illustrating an example of scalar multiplication processing on an elliptic curve according to the embodiment mode;

FIG. 4 is a flow chart for illustrating an example of processing of calculating a Montgomery constant according to the embodiment mode;

FIG. 5 is a flow chart for illustrating an example of doubling processing on an elliptic curve according to the embodiment mode;

FIG. 6 is a flow chart for illustrating an example of addition processing on the elliptic curve according to the embodiment mode;

FIG. 7 is a flow chart for illustrating an example of addition processing on a field Fₚ according to the embodiment mode;

FIG. 8 is a flow chart for illustrating an example of subtraction processing on the field Fₚ according to the embodiment mode;

FIG. 9 is a flow chart for illustrating an example of subtraction processing according to the embodiment mode;

FIG. 10 is a flow chart for illustrating an example of Montgomery multiplication processing according to the embodiment mode;

FIG. 11 is a flow chart for illustrating an example of processing of calculating work and others in the Montgomery multiplication processing according to the embodiment mode;

FIG. 12 is a diagram for illustrating a configuration example of an ECDSA key pair generating apparatus according to Second Embodiment;

FIG. 13 is a flow chart for illustrating an example of ECDSA key pair generating processing according to Second Embodiment;

FIG. 14 is a diagram for illustrating a configuration example of an ECDSA signature generating apparatus according to Second Embodiment;

FIG. 15 is a flow chart for illustrating an example of ECDSA signature generating processing according to Second Embodiment;

FIG. 16 is a diagram for illustrating a configuration example of an ECDSA signature verifying apparatus according to Second Embodiment;

FIG. 17 is a flow chart for illustrating an example of ECDSA signature verifying processing according to Second Embodiment.

### DETAILED DESCRIPTION OF THE PREFERRED EMBODIMENTS

Embodiment modes of the present invention are described below with reference to the accompanying drawings. However, it should be noted that the embodiment modes described below are merely examples for achieving the present invention and do not limit a technical scope of the present invention. Components common across the respective drawings are denoted by the same reference symbols. In the embodiment modes of the present invention, “elliptic curve” refers to an Weierstrass form elliptic curve unless otherwise noted.

### First Embodiment

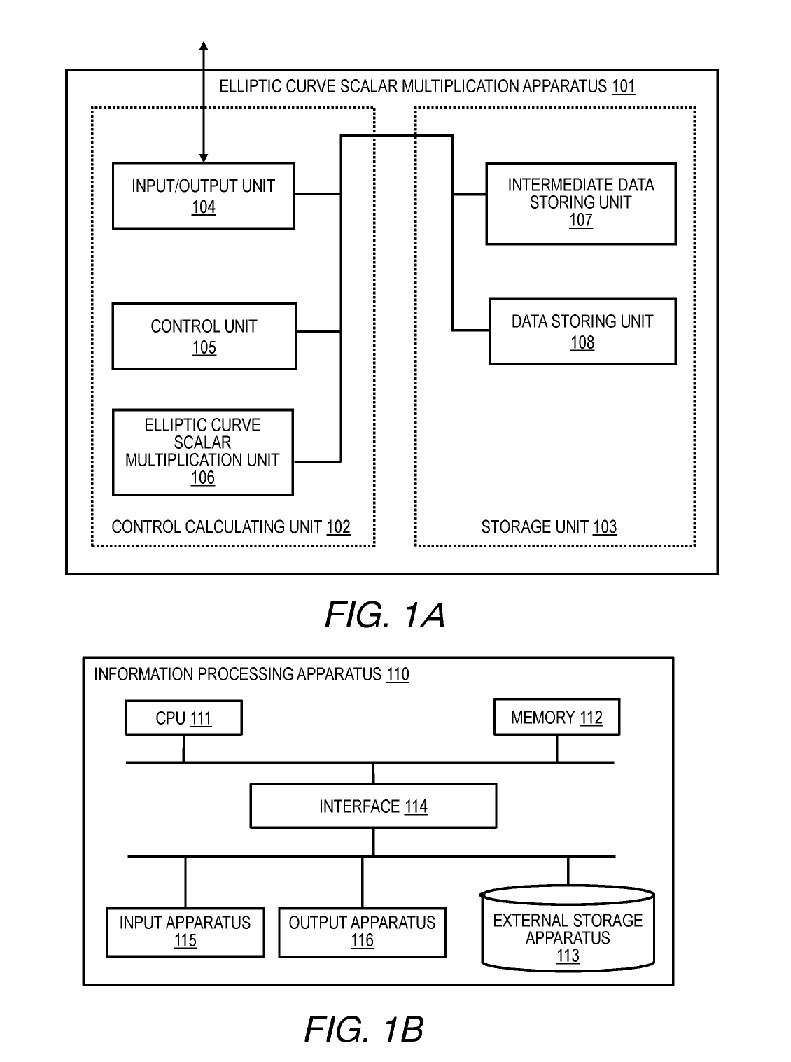

FIG. 1A is a diagram for illustrating a configuration example of an elliptic curve scalar multiplication apparatus according to an embodiment mode of the present invention. An elliptic curve scalar multiplication apparatus 101 includes a control calculating unit 102 and a storage unit 103. The control calculating unit 102 includes an input/output unit 104 configured to input data to be calculated and output a calculation result, a control unit 105 configured to handle overall control of the elliptic curve scalar multiplication apparatus 101, and an elliptic curve scalar multiplication unit 106 configured to actually calculate a scalar multiple on an elliptic curve.

The storage unit 103 includes an intermediate data storing unit 107 configured to store intermediate data, which is generated during processing as the need arises, and a data storing unit 108 configured to store a parameter of an elliptic curve and other types of data. The data storing unit 108 stores, for example, an elliptic curve y²=x³+ax+b (4a²−27b³≠0, a,b∈ Fₚ) input via the input/output unit 104, a point P that is a prime order on the elliptic curve, P=(x₁,y₁), an order q of the point P, an integer l, and others.

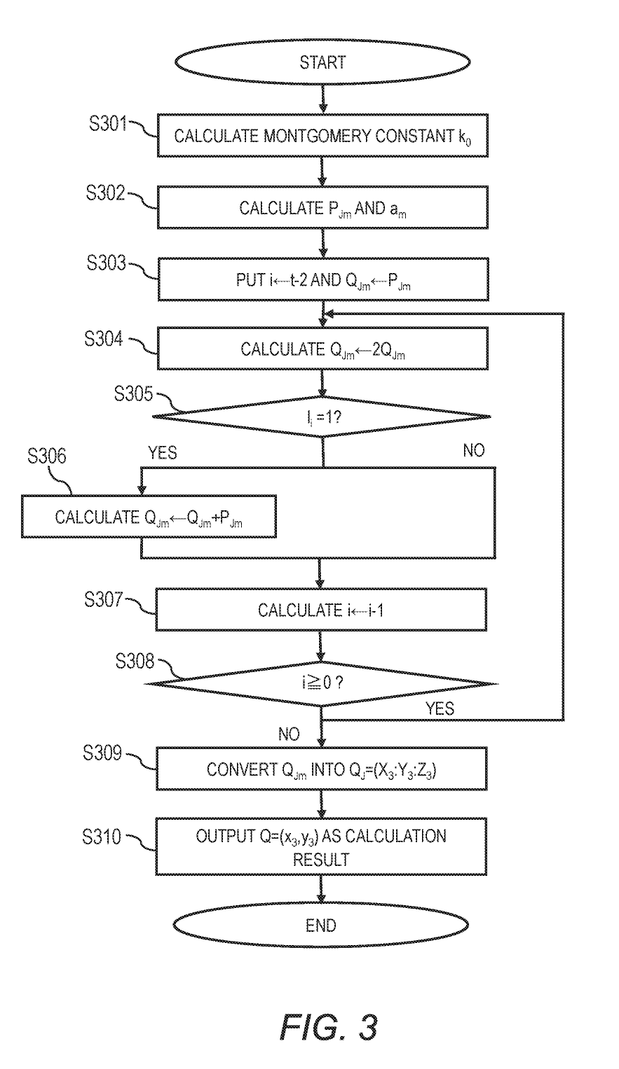

The elliptic curve scalar multiplication unit 106 uses information stored in the data storing unit 108 to execute scalar multiplication processing, and obtains a calculation result Q=lP=(x₃,y₃) expressed with Jacobian coordinates. The scalar multiplication processing follows a flow chart that is illustrated in FIG. 3 and described later.

FIG. 1B is a diagram for illustrating a hardware configuration example of an information processing apparatus. An information processing apparatus 110 includes a CPU 111, a memory 112, an external storage apparatus 113 including a hard disk apparatus, an input apparatus 115, which is a keyboard or the like, an output apparatus 116, such as a display, and an interface 114 to the external storage apparatus 113, the input apparatus, and the output apparatus. The elliptic curve scalar multiplication apparatus 101 is built on, for example, the information processing apparatus 110 of FIG. 1B.

The processing units of the control calculating unit 102 are implemented as, for example, processes manifested on the information processing apparatus 110 by executing, with the CPU 111, programs (also called code modules) that are loaded onto the memory 112. The memory 112 and the external storage apparatus 113 are used as the storing units of the storage unit 103 in the elliptic curve scalar multiplication apparatus 101.

The programs described above are stored in the external storage apparatus 113 in advance, and are loaded onto the memory 112 as the need arises to be executed by the CPU 111. The programs may instead be loaded onto the memory 112 as the need arises from a computer-readable, portable, non-transitory, storage medium, such as a CD-ROM, via an external storage apparatus that handles this type of storage medium. Alternatively, the programs may be installed from the storage medium into the external storage apparatus 113 to be loaded onto the memory 112 from the external storage apparatus 113 as the need arises.

The programs may be loaded onto the memory after being downloaded to the external storage apparatus 113 via, for example, a network connection apparatus (not shown) with the use of a transmission signal that is a type of media readable to information processing apparatus on a network. The programs may instead be loaded onto the memory 112 directly from a network. The same applies to other apparatus described later in the embodiment mode of the present invention.

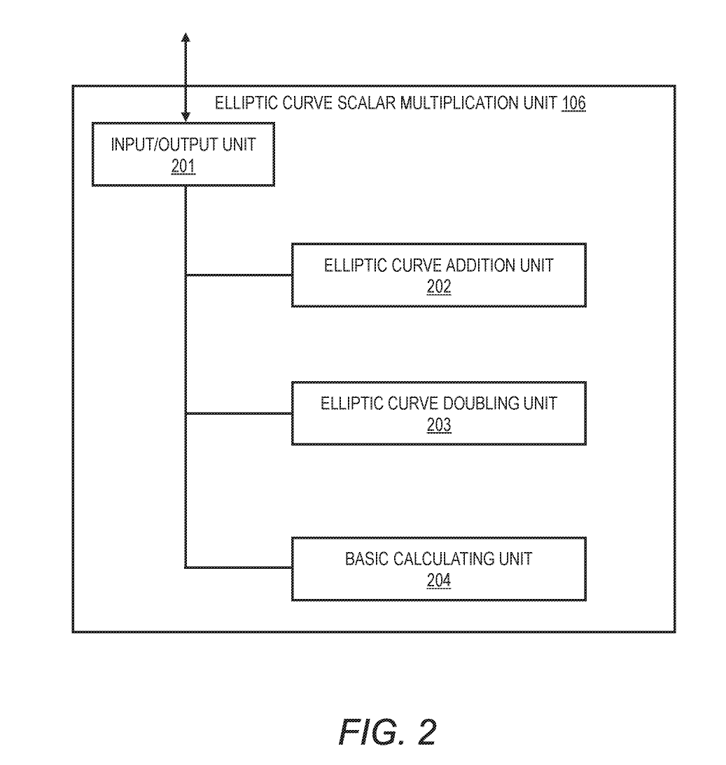

FIG. 2 is a diagram for illustrating a configuration example of the elliptic curve scalar multiplication unit 106. The elliptic curve scalar multiplication unit 106 includes an input/output unit 201, an elliptic curve addition unit 202, an elliptic curve doubling unit 203, and a basic calculating unit 204. The input/output unit 201 is configured to input and output data. The elliptic curve addition unit 202 is configured to add two points on an elliptic curve. The elliptic curve doubling unit 203 is configured to perform the doubling of a point on an elliptic curve. The basic calculating unit 204 is called up by the elliptic curve addition unit 202 and the elliptic curve doubling unit 203 as the need arises to perform, for example, an arithmetic operation on the field of definition of an elliptic curve, four arithmetic operations that use modulo operation (mod), and Montgomery arithmetic.

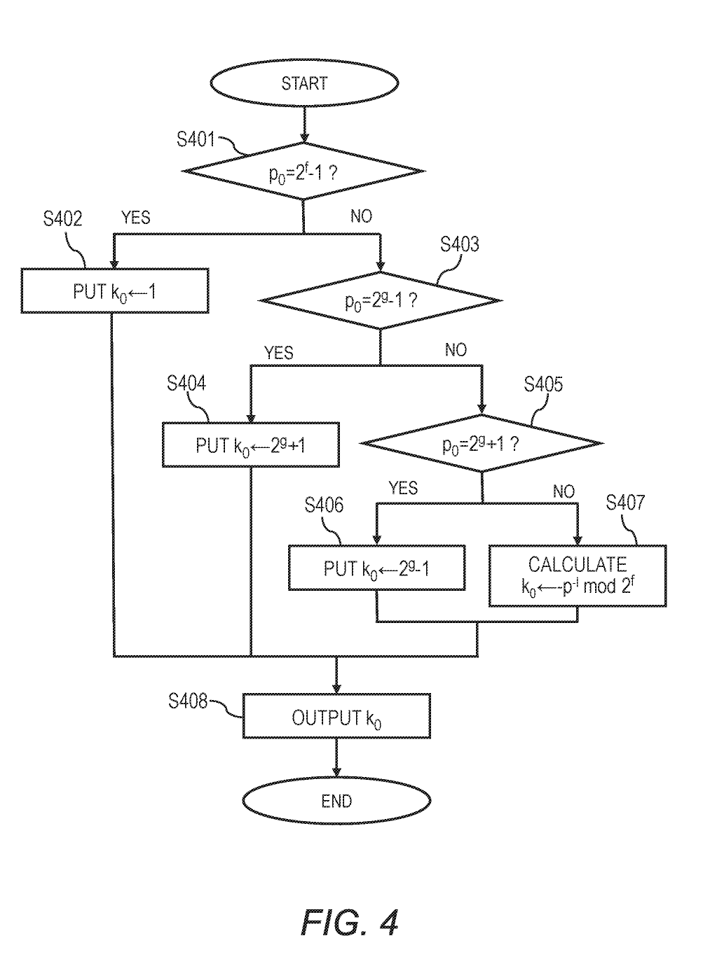

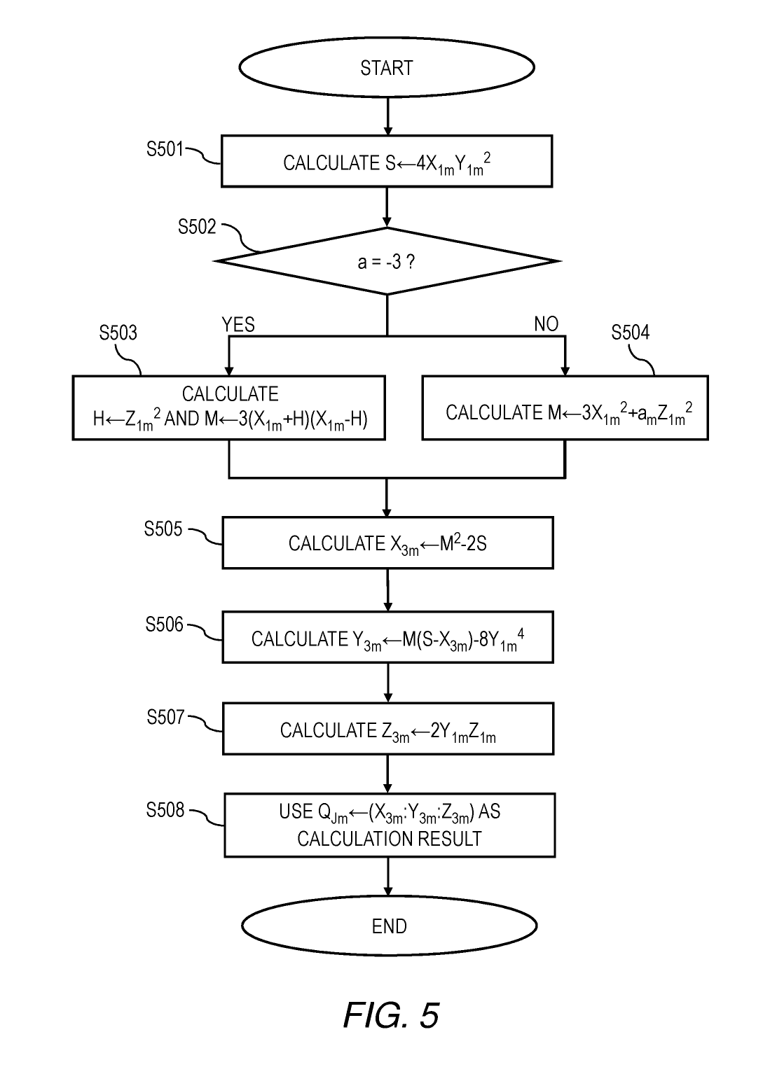

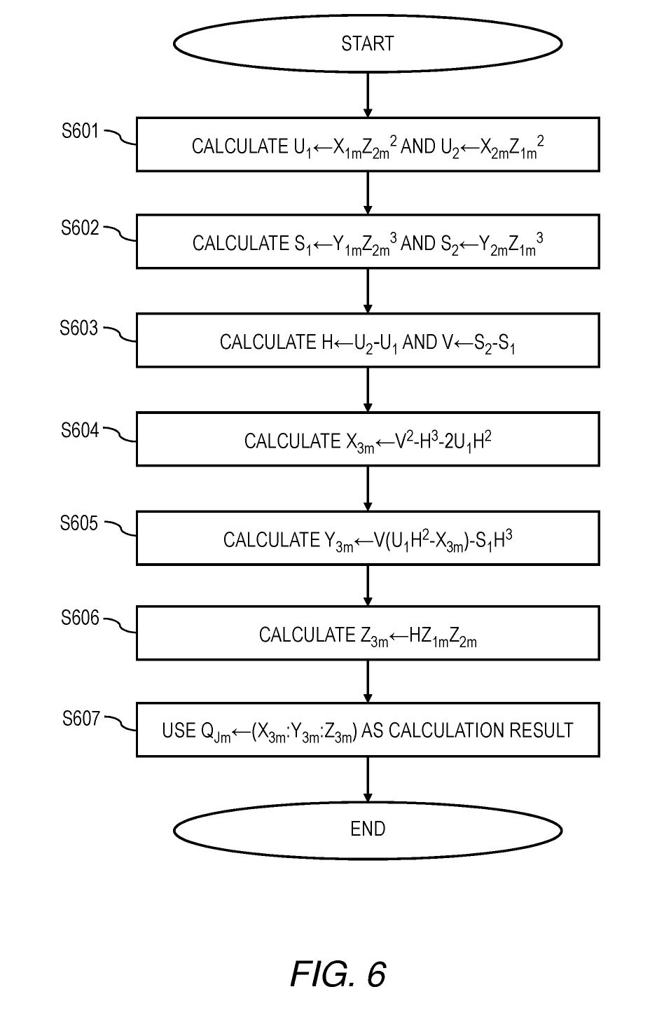

FIG. 3 is a flow chart for illustrating an example of scalar multiplication processing. A method of calculating Q=lP when an integer that satisfies 0<l<q is expressed in binary as l=l₀+l₁×2+ . . . +lₜ₋₁×2^{t-1} (lₜ₋₁=1) is described. A symbol “R” in steps described below represents a value defined as R=2^{fk} with the use of a minimum integer k that satisfies p<2^{fk} in relation to f bits (f is an integer equal to or larger than 1), which are the unit of breaking data into pieces in multiple-precision integer arithmetic performed by the elliptic curve scalar multiplication unit 106. The notation “a←b” in the following description indicates that a is substituted with b.

<Step S301> The basic calculating unit 204 calculates a Montgomery constant k₀. The Montgomery constant k₀ is calculated by processing that is described later with reference to FIG. 4.

<Step S302> The basic calculating unit 204 calculates P_{Jm}=(X₁ₘ:Y₁ₘ:Z₁ₘ)←(x₁R mod p:y₁R mod p:R mod p) and calculates aₘ←aR mod p for a parameter a of the elliptic curve y²=x³+ax+b.

<Step S303> The basic calculating unit 204 puts i←t−2 and Q_{Jm}←P_{Jm}.

<Step S304> The elliptic curve doubling unit 203 calculates Q_{Jm}←2Q_{Jm}. The calculation of 2Q_{Jm} is made by processing that is described later with reference to FIG. 5.

<Step S305> The basic calculating unit 204 determines whether or not lᵢ=1 is true, and proceeds to Step S306 when determining that lᵢ=1 is true, and to Step S307 when determining that lᵢ=1 is not true.

<Step S306> The elliptic curve addition unit 202 calculates Q_{Jm}←Q_{Jm}+P_{Jm}. The calculation of Q_{Jm}+P_{Jm} is made by processing that is described later with reference to FIG. 6.

<Step S307> The basic calculating unit 204 calculates i←i−1.

<Step S308> The basic calculating unit 204 determines whether or not i≧0 is true, returns to Step S304 when determining that i≧0 is true, and proceeds to Step S309 when determining that i≧0 is not true.

<Step S309> The basic calculating unit 204 converts Q_{Jm} into Q_{J} by calculating Q_{J}=(X₃:Y₃:Z₃)←(X₃ₘR⁻¹ mod p:Y₃ₘR⁻¹ mod p:Z₃ₘR⁻¹ mod p).

<Step S310> The basic calculating unit 204 calculates Q=(x₃,y₃)←(X₃/Z₃²,Y₃/Z₃³) from the scalar multiplication result Q_{J}=(X₃:Y₃:Z₃), and determines Q as the calculation result.

FIG. 4 is a flow chart for illustrating an example of the processing of calculating the Montgomery constant k₀ in Step S301. Input values are the least significant f bits p₀ of the prime number p, which is used to define the prime field Fₚ and expressed as p=p₀+p₁c+ . . . +pₙcⁿ⁻¹, where c equals 2^{f} and f is an integer equal to or larger than 1.

<Step S401> The basic calculating unit 204 determines whether or not p₀=2^{f}−1 is true, and proceeds to Step S402 when determining that p₀=2^{f}−1 is true, and to Step S403 when determining that p₀=2^{f}−1 is not true.

<Step S402> The basic calculating unit 204 puts k₀←1, and proceeds to Step S408.

<Step S403> The basic calculating unit 204 determines, for an integer that satisfies f/2≦g<f, whether or not p₀=2^{g}−1 is true, and proceeds to Step S404 when determining that p₀=2^{g}−1 is true, and to Step S405 when determining that p₀=2^{g}−1 is not true.

<Step S404> The basic calculating unit 204 puts k₀←2^{g}+1, and proceeds to Step S408.

<Step S405> The basic calculating unit 204 determines, for an integer that satisfies f/2≦g<f, whether or not p₀=2^{g}+1 is true, and proceeds to Step S406 when determining that p₀=2^{g}+1 is true, and to Step S407 when determining that p₀=2^{g}+1 is not true.

<Step S406> The basic calculating unit 204 puts k₀←2^{g}−1, and proceeds to Step S408.

<Step S407> The basic calculating unit 204 calculates k₀←−p⁻¹ mod 2^{f}, and proceeds to Step S408.

<Step S408> The input/output unit 201 outputs k₀.

The basic calculating unit 204, depending on the value of p₀, thus changes the method of calculating the Montgomery constant k₀, thereby finishing the calculation of the Montgomery constant k₀ quickly. Specifically, when p₀ is 2^{f}−1, 2^{g}−1, or 2^{g}+1, in particular, the basic calculating unit 204 does not need to calculate −p⁻¹ mod 2^{f}, and can quickly determine the Montgomery constant k₀ by simple substitution.

FIG. 5 is a flow chart for illustrating an example of the doubling processing Q_{Jm}←2Q_{Jm} that is executed by the elliptic curve doubling unit 203 in Step S304. The coordinates of Q_{Jm} when input are (X₁ₘ:Y₁ₘ:Z₁ₘ).

<Step S501> The elliptic curve doubling unit 203 calculates S←4X₁ₘY₁ₘ².

<Step S502> The basic calculating unit 204 determines whether or not a=−3 is true, and proceeds to Step S503 when determining that a=−3 is true, and to Step S504 when determining that a=−3 is not true.

<Step S503> The elliptic curve doubling unit 203 calculates H←Z₁ₘ² and M←3(X1m+H)(X1m−H), and proceeds to Step S505.

<Step S504> The elliptic curve doubling unit 203 calculates M←3X₁ₘ²+aₘZ₁ₘ², and proceeds to Step S505.

<Step S505> The elliptic curve doubling unit 203 calculates X₃ₘ←M²−2S.

<Step S506> The elliptic curve doubling unit 203 calculates Y₃ₘ←M(S−X₃ₘ)−8Y₁ₘ⁴.

<Step S507> The elliptic curve doubling unit 203 calculates Z₃ₘ←2Y₁ₘZ₁ₘ.

<Step S508> The input/output unit 201 outputs Q_{Jm}←(X₃ₘ:Y₃ₘ:Z₃ₘ) as the calculation result.

FIG. 6 is a flow chart for illustrating an example of the addition processing Q_{Jm}←Q_{Jm}+P_{Jm} that is executed by the elliptic curve addition unit 202 in Step S306. The coordinates of P_{Jm} and Q_{Jm} when input are (X₁:Y₁:Z₁) and (X₂:Y₂:Z₂), respectively.

<Step S601> The elliptic curve addition unit 202 calculates U₁←X₁ₘZ₂ₘ² and U₂←X₂ₘZ₁ₘ².

<Step S602> The elliptic curve addition unit 202 calculates S₁←Y₁ₘZ₂ₘ³ and S₂←Y₂ₘZ₁ₘ³.

<Step S603> The elliptic curve addition unit 202 calculates H←U₂−U₁ and V←S₂−S₁.

<Step S604> The elliptic curve addition unit 202 calculates X₃ₘ←V²−H³−2U₁H².

<Step S605> The elliptic curve addition unit 202 calculates Y₃ₘ←V(U₁H²−X₃ₘ)−S₁H³.

<Step S606> The elliptic curve addition unit 202 calculates Z₃ₘ←HZ₁ₘZ₂ₘ.

<Step S607> The input/output unit 201 outputs Q_{Jm}←(X₃ₘ:Y₃ₘ:Z₃ₘ) as the calculation result.

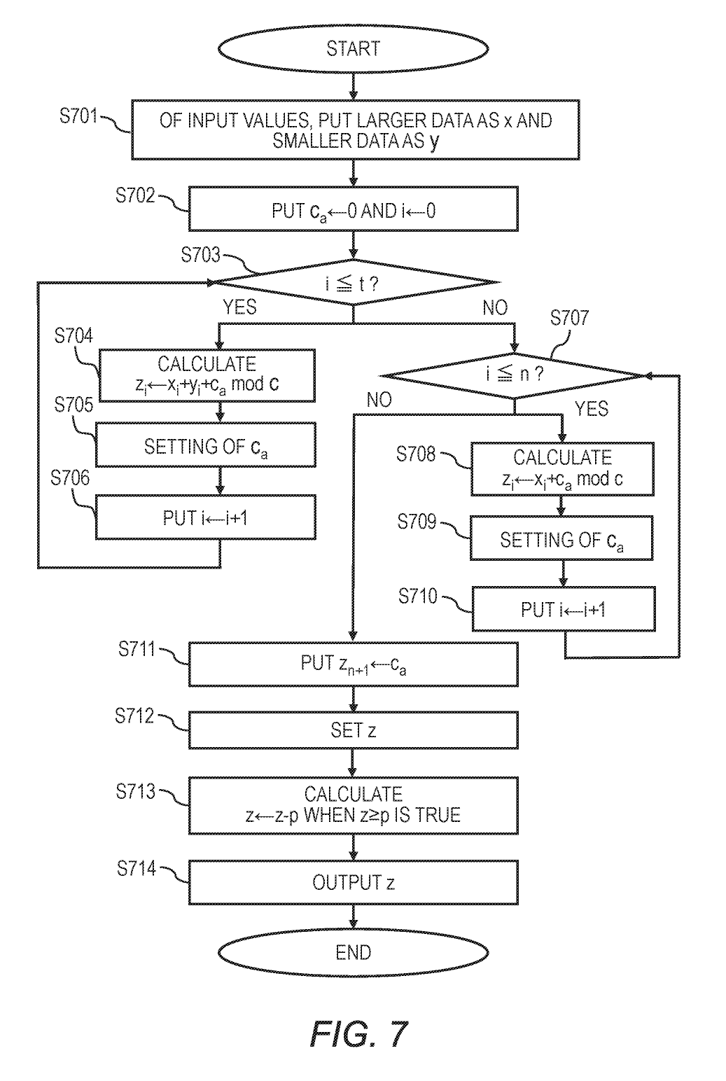

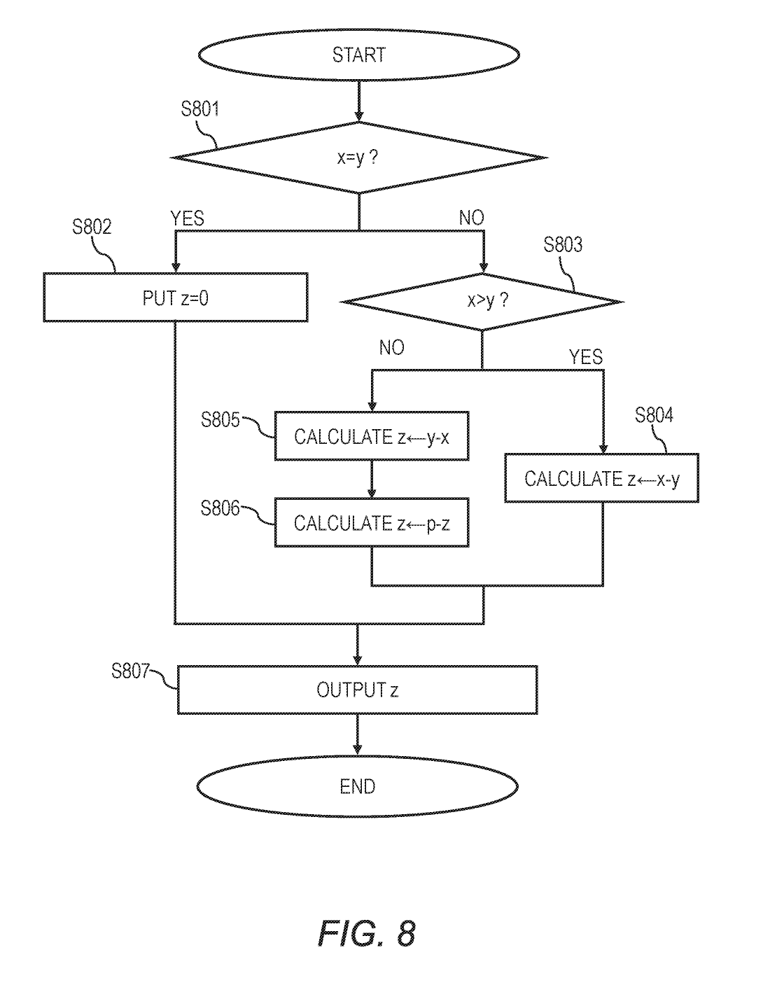

FIG. 7 is a flow chart for illustrating an example of multiple-precision integer addition processing z←x+y mod p that is used in, for example, Step S304, Step S306 and other similar types of processing when inputs are x (x<p), y (y<p), and the prime number p.

<Step S701> The basic calculating unit 204 re-designates larger data of the input values as x and smaller data as y. The data x and the data y are expressed as data broken into the units of f bits, x=x₀+x₁c+ . . . +xₙcⁿ⁻¹ and y=y₀+y₁c+ . . . +yₜc^{t-1} (c=2^{f}, f≧1, 1≦t≦n).

<Step S702> The basic calculating unit 204 puts cₐ←0 and i←0.

<Step S703> The basic calculating unit 204 determines whether or not i≦t is true, and proceeds to Step S704 when i≦t is true, and to Step S707 otherwise.

<Step S704> The basic calculating unit 204 calculates zᵢ←xᵢ+yᵢ+cₐ mod c.

<Step S705> The basic calculating unit 204 determines whether or not zᵢ<b is true, and puts cₐ←0 when zᵢ<b is true, and puts cₐ←1 otherwise.

<Step S706> The basic calculating unit 204 puts i←i+1, and proceeds to Step S703.

<Step S707> The basic calculating unit 204 determines whether or not i≦n is true, and proceeds to Step S708 when i≦n is true, and to Step S711 otherwise.

<Step S708> The basic calculating unit 204 calculates zᵢ←xᵢ+cₐ mod c.

<Step S709> The basic calculating unit 204 determines whether or not zᵢ<c is true, and puts cₐ←0 when zᵢ<c true, and as cₐ←1 otherwise.

<Step S710> The basic calculating unit 204 puts i←i+1, and returns to Step S707.

<Step S711> The basic calculating unit 204 puts zₙ₊₁←cₐ.

<Step S712> The basic calculating unit 204 puts z=z₀+z₁c+ . . . +zₙcⁿ⁻¹+zₙ₊₁cⁿ.

<Step S713> The basic calculating unit 204 determines whether or not z≧p is true, and calculates z←z−p when z≧p is true. The basic calculating unit 204 calculates z−p by a calculation method that is illustrated in a flow chart of FIG. 8.

<Step S714> The input/output unit 201 outputs z.

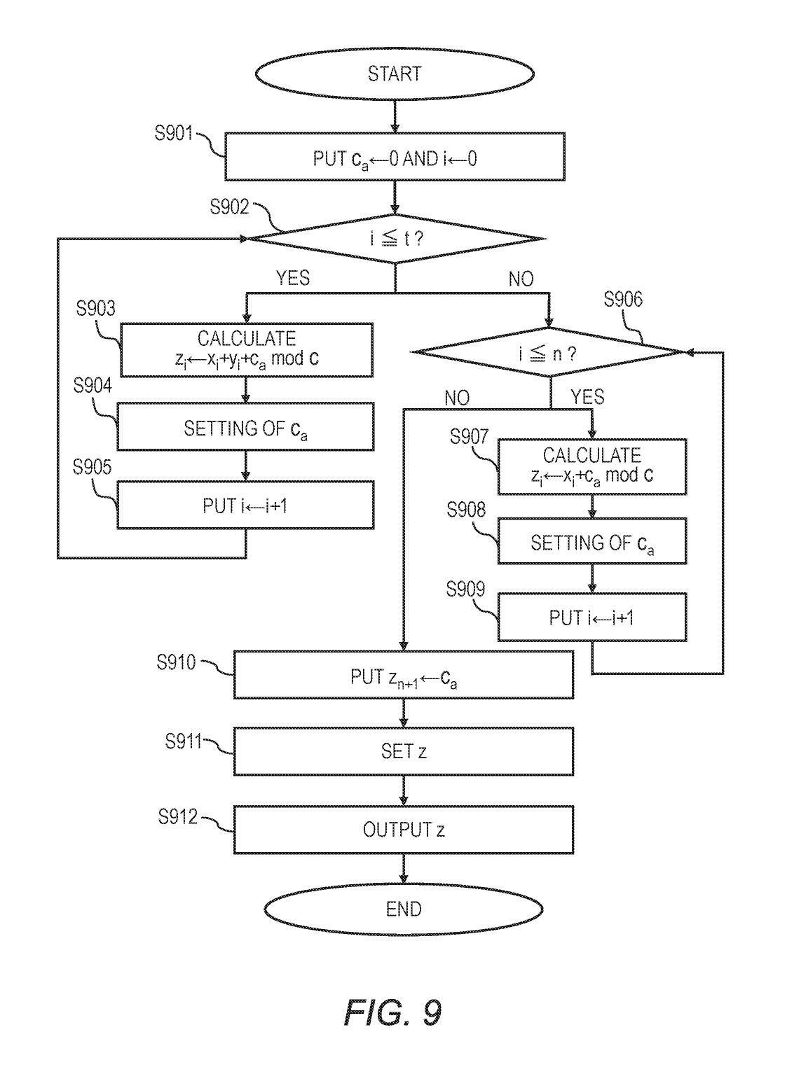

Subtraction processing that is used in, for example, Step S304, Step S306, and Step S713 is described next. FIG. 8 is a flow chart for illustrating an example of subtraction processing z←x−y on the prime field Fₚ when inputs are x, y, and the prime number is p.

<Step S801> The basic calculating unit 204 determines whether or not x=y is true, and proceeds to Step S802 when determining that x=y is true, and to Step S803 when determining that x=y is not true.

<Step S802> The basic calculating unit 204 puts z←0, and proceeds to Step S807.

<Step S803> The basic calculating unit 204 determines whether or not x>y is true, and proceeds to Step S804 when determining that x>y is true, and to Step S805 when determining that x>y is not true.

<Step S804> The basic calculating unit 204 calculates z←x−y, and proceeds to Step S807. The basic calculating unit 204 calculates x−y by a calculation method that is described later with reference to FIG. 9.

<Step S805> The basic calculating unit 204 calculates z←y−x. The basic calculating unit 204 calculates y−x by the calculation method that is illustrated in the flow chart of FIG. 8.

<Step S806> The basic calculating unit 204 calculates z←p−z, and proceeds to Step S807. The basic calculating unit 204 calculates p−z by the calculation method that is described later with reference to FIG. 9.

<Step S807> The input/output unit 201 outputs z.

The multiple-precision integer subtraction processing in Step S804, Step S805, and other steps is described next. FIG. 9 is a flow chart for illustrating an example of subtraction processing z←x−y when inputs are x and y (x>y,x=x₀+x₁c+ . . . +xₙcⁿ⁻¹,y=y₀+y₁c+ . . . +yₜc^{t-1} (c=2^{f}, f≧1, 1≦t≦n)).

<Step S901> The basic calculating unit 204 puts cₐ←0 and i←0.

<Step S902> The basic calculating unit 204 determines whether or not i≦t is true, and proceeds to Step S903 when determining that i≦t is true, and to Step S906 when determining that i≦t is not true.

<Step S903> The basic calculating unit 204 calculates zᵢ←xᵢ−yᵢ+cₐ mod c.

<Step S904> The basic calculating unit 204 determines whether or not zᵢ<b is true, and puts cₐ←0 when determining that zᵢ<b is true, and as cₐ←−1 when determining that zᵢ<b is not true.

<Step S905> The basic calculating unit 204 puts i←i+1, and returns to Step S902.

<Step S906> The basic calculating unit 204 determines whether or not i≦n is true, and proceeds to Step S907 when determining that i≦n is true, and to Step S910 when determining that i≦n is not true.

<Step S907> The basic calculating unit 204 calculates zᵢ←xᵢ+cₐ mod c.

<Step S908> The basic calculating unit 204 determines whether or not zᵢ<c is true, and puts cₐ←0 when determining that zᵢ<c true, and puts cₐ←−1 when determining that zᵢ<c is not true.

<Step S909> The basic calculating unit 204 puts i←i+1, and returns to Step S906.

<Step S910> The basic calculating unit 204 puts zₙ₊₁←cₐ.

<Step S911> The basic calculating unit 204 puts z=z₀+z₁c+ . . . +zₙcⁿ⁻¹+zₙ₊₁cⁿ.

<Step S912> The input/output unit 201 outputs z.

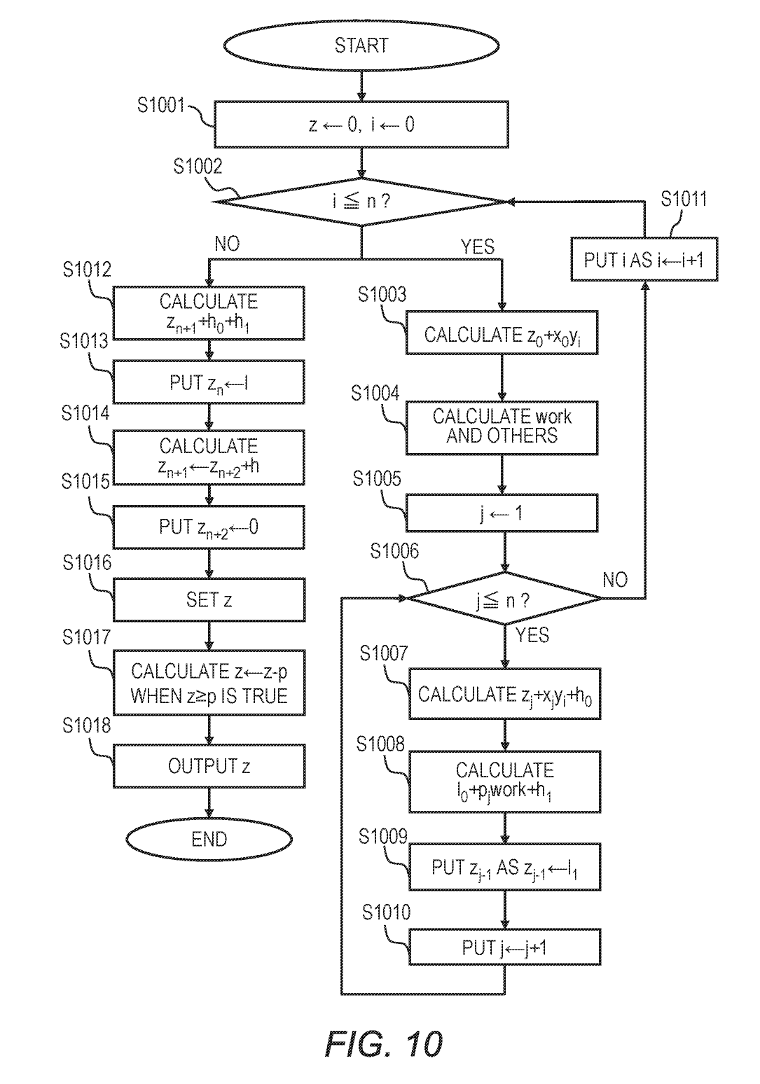

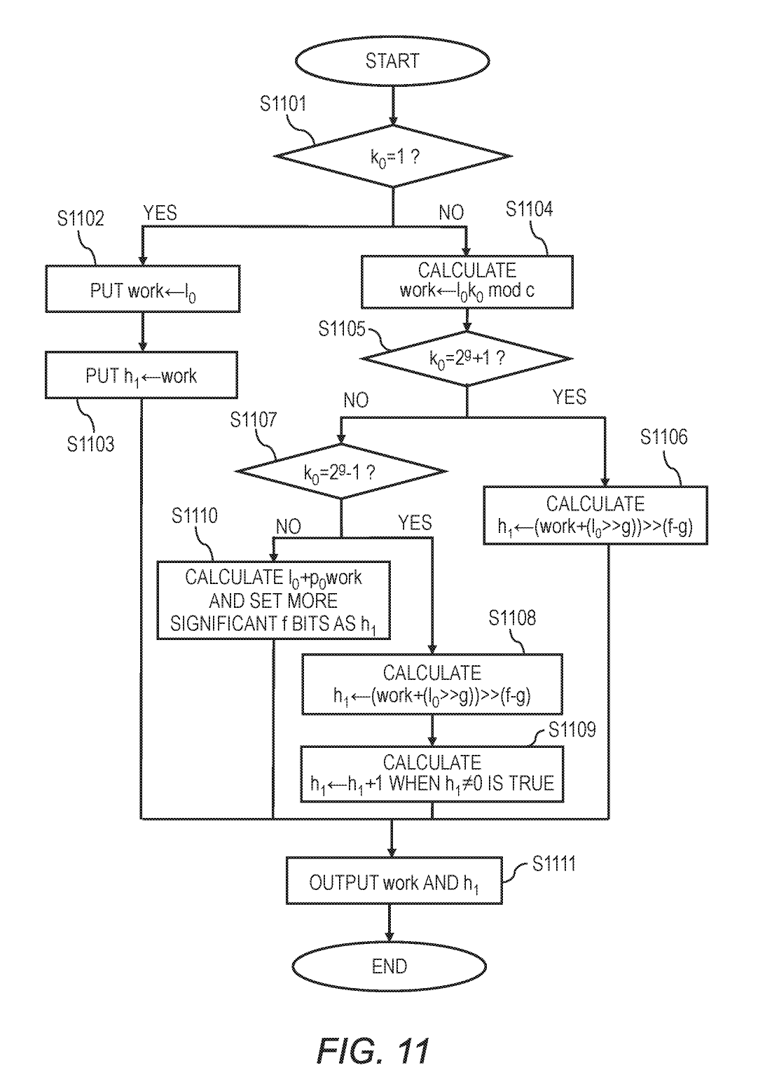

Montgomery multiplication processing in Step S304, Step S306, and other steps is described next. FIG. 10 is a flow chart for illustrating an example of Montgomery multiplication processing z←xyR⁻¹ mod p when inputs are x and y. In a calculation method described below, x, y, and p are defined as x=x₀+x₁c+ . . . +xₙcⁿ⁻¹, y=y₀+y₁c+ . . . +yₙcⁿ⁻¹, and p=p₀+p₁c+ . . . +pₙcⁿ⁻¹ (c=2^{f}, f≧1, y<p, x<p, 1≦n).

<Step S1001> The basic calculating unit 204 puts z←0 and i←0.

<Step S1002> The basic calculating unit 204 determines whether or not i≦n is true, and proceeds to Step S1003 when determining that i≦n is true, and to Step S1012 when determining that i≦n is not true.

<Step S1003> The basic calculating unit 204 calculates z₀+x₀×yᵢ, puts the least significant f bits as l₀, and puts the most significant f bits as h₀.

<Step S1004> The basic calculating unit 204 calculates work and others by a calculation method that is illustrated in FIG. 11.

<Step S1005> The basic calculating unit 204 puts j←1.

<Step S1006> The basic calculating unit 204 determines whether or not j≦n is true, and proceeds to Step S1007 when determining that j≦n is true, and to Step S1011 when determining that j≦n is not true.

<Step S1007> The basic calculating unit 204 calculates zⱼ+xⱼyᵢ+h₀, puts the least significant f bits as l₀, and puts the most significant f bits as h₀.

<Step S1008> The basic calculating unit 204 calculates l₀+pⱼwork+h₁, puts the least significant f bits as l₁, and puts the most significant f bits as h₁.

<Step S1009> The basic calculating unit 204 puts zⱼ₋₁←l₁.

<Step S1010> The basic calculating unit 204 puts j←j+1, and returns to Step S1006.

<Step S1011> The basic calculating unit 204 puts i←i+1, and returns to Step S1006.

<Step S1012> The basic calculating unit 204 calculates zₙ₊₁+h₀+h₁, puts the least significant f bits as l, and puts the most significant f bits as h.

<Step S1013> The basic calculating unit 204 puts zₙ←l.

<Step S1014> The basic calculating unit 204 calculates zₙ₊₁←zₙ₊₂+h.

<Step S1015> The basic calculating unit 204 puts zₙ₊₂←0.

<Step S1016> The basic calculating unit 204 puts z=z₀+z₁c+ . . . +zₙcⁿ⁻¹ +zₙ₊₁cⁿ.

<Step S1017> The basic calculating unit 204 determines whether or not z≧p is true, calculates z←z−p when determining that z≧p is true, and does not execute the processing when determining that z≧p is not true. The basic calculating unit 204 calculates z−p by the calculation method of FIG. 8.

<Step S1018> The input/output unit 201 outputs z.

The calculation of work and others in Step S1004 is described next. FIG. 11 is a flow chart for illustrating an example of processing of calculating work and others when inputs are k₀, l₀, and c.

<Step S1101> The basic calculating unit 204 determines whether or not k₀=1 is true, and proceeds to Step S1102 when determining that k₀=1 is true, and to Step S1104 when determining that k₀=1 is not true.

<Step S1102> The basic calculating unit 204 puts work←l₀.

<Step S1103> The basic calculating unit 204 puts h₁←work, and proceeds to Step S1111.

<Step S1104> The basic calculating unit 204 calculates work←l₀k₀ mod c.

<Step S1105> The basic calculating unit 204 determines whether or not k₀=2^{g}+1 is true, and proceeds to Step S1106 when determining that k₀=2^{g}+1 is true, and to Step S1107 when determining that k₀=2^{g}+1 is not true.

<Step S1106> The basic calculating unit 204 calculates h₁←(work+(l₀>>g))>>(f−g), and proceeds to Step S1111.

<Step S1107> The basic calculating unit 204 determines whether or not k₀=2^{g}−1 is true, and proceeds to Step S1108 when determining that k₀=2^{g}−1 is true, and to Step S1110 when determining that k₀=2^{g}−1 is not true.

<Step S1108> The basic calculating unit 204 calculates h₁←(work+(l₀>>g))>>(f−g).

<Step S1109> The basic calculating unit 204 determines whether or not h₁≠0 is true, and calculates h₁←h₁+1 and proceeds to Step S1111 when determining that h₁≠0 is true. When determining that h₁=0 is true, the basic calculating unit 204 proceeds to Step S1111 without executing the processing.

<Step S1110> The basic calculating unit 204 calculates l₀+p₀work, puts the most significant f bits as h₁, and proceeds to Step S1111.

<Step S1111> The input/output unit 201 outputs work and h₁.

In the manner described above, the basic calculating unit 204 can finish Montgomery multiplication quickly by optimizing calculation and replacing one session of f-bit multiplication per loop with addition and shift operation, which are lighter in processing load, when k₀ is 2^{g}−1 or 2^{g}+1, in other words, when p₀ is 2^{g}+1 or 2^{g}−1(f/2≦g<f). The basic calculating unit 204 can thus reduce the number of times f-bit multiplication is executed from 2n²+n to 2n² by n times, and is therefore capable of fast multiplication processing.

### Second Embodiment

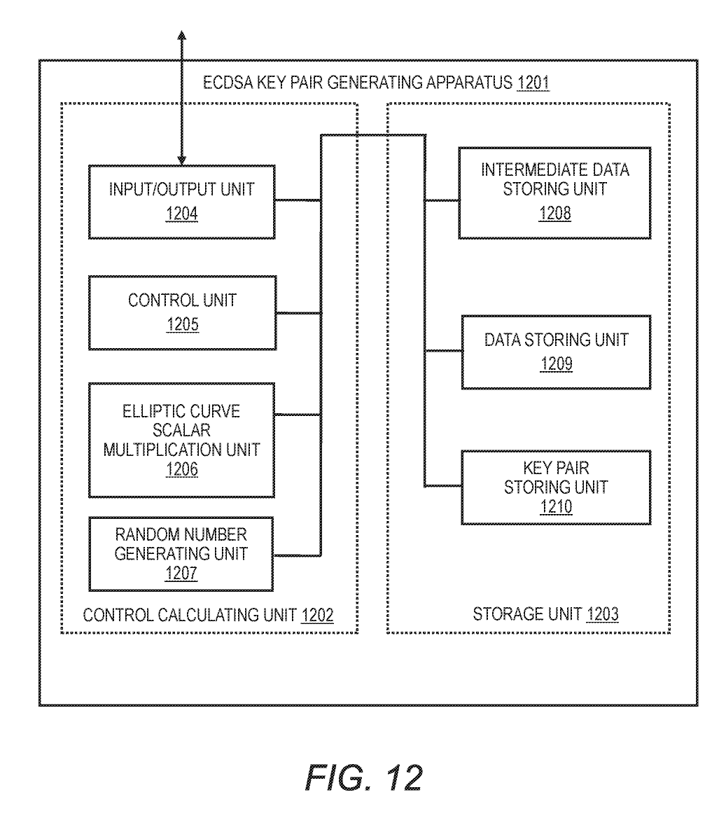

An elliptic curve encryption and signature method to which the elliptic curve scalar multiplication apparatus 101 of the first embodiment is applied is described in this embodiment. FIG. 12 is a diagram for illustrating a configuration example of an ECDSA key pair generating apparatus 1201. The ECDSA key pair generating apparatus 1201 includes a control calculating unit 1202 and a storage unit 1203. The control calculating unit 1202 includes an input/output unit 1204, a control unit 1205, an elliptic curve scalar multiplication unit 1206, and a random number generating unit 1207. The ECDSA key pair generating apparatus 1201 is built on, for example, the information processing apparatus 110 illustrated in FIG. 1B.

The input/output unit 1204 is configured to receive an input of, for example, a parameter of an elliptic curve, field-of-definition information, the base point G, and the order of G. The input/output unit 1204 is also configured to output a generated key pair. The control unit 1205 is configured to control the ECDSA key pair generating apparatus 1201. The elliptic curve scalar multiplication unit 1206 is configured to calculate an integral multiple of the base point G.

The elliptic curve scalar multiplication unit 1206 can be built from, for example, the elliptic curve scalar multiplication apparatus 101 of the first embodiment. The elliptic curve scalar multiplication unit 1206 in this case can perform basic arithmetics such as calculation on a field of definition, modulo operation (mod), and comparison by calling up the basic calculating unit 205 through the input/output unit 104. The same applies to elliptic curve scalar multiplication units that are included in other apparatus described later. The random number generating unit 1207 is configured to generate a random number.

The storage unit 1203 includes an intermediate data storing unit 1208, a data storing unit 1209, and a key pair storing unit 1210. The intermediate data storing unit 1208 is configured to store intermediate data generated during calculation that is made by the control calculating unit 1202. The data storing unit 1209 is configured to store a parameter of an elliptic curve, a base point, the order of the base point, field-of-definition information, and the like that are input via the input/output unit 1204. The key pair storing unit 1210 is configured to store key pair information generated by the control calculating unit 1202.

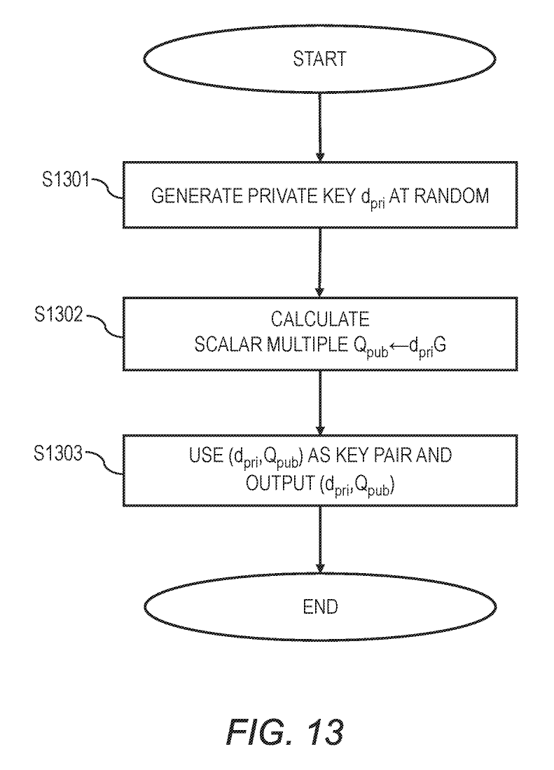

The flow of operation of the key pair storing unit 1210 is described next on the assumption that the operation of the ECDSA key pair generating apparatus 1201 is controlled by the control unit 1205. The data storing unit 1209 stores, for example, the elliptic curve y²=x³+ax+b(4a²−27b³≠0, a,b∈ Fₚ), the field of definition Fₚ, the base point G of the elliptic curve, G=(x_{g},y_{g}), and the order q (a prime number) of the base point G input via the input/output unit 1204. The control calculating unit 1202 uses information stored in the data storing unit 1209 to execute key pair generating processing, which is, for example, processing that is described later with reference to FIG. 13. The key pair storing unit 1210 stores the key pair generated by the control calculating unit 1202, the input/output unit 1204 outputs the key pair, and the operation is then ended.

FIG. 13 is a flow chart for illustrating an example of the key pair generating processing that is executed by the control calculating unit 1202.

<Step S1301> The random number generating unit 1207 generates at random an integer dₚᵣᵢ that satisfies 0<dₚᵣᵢ<q, and uses dₚᵣᵢ as a private key.

<Step S1302> The elliptic curve scalar multiplication unit 1206 calculates a scalar multiple Q_{pub}←dₚᵣᵢG=(x_{Q},y_{Q}), and uses Q_{pub} as a public key.

<Step S1304> The input/output unit 1204 outputs (dₚᵣᵢ,Q_{pub}) as a key pair.

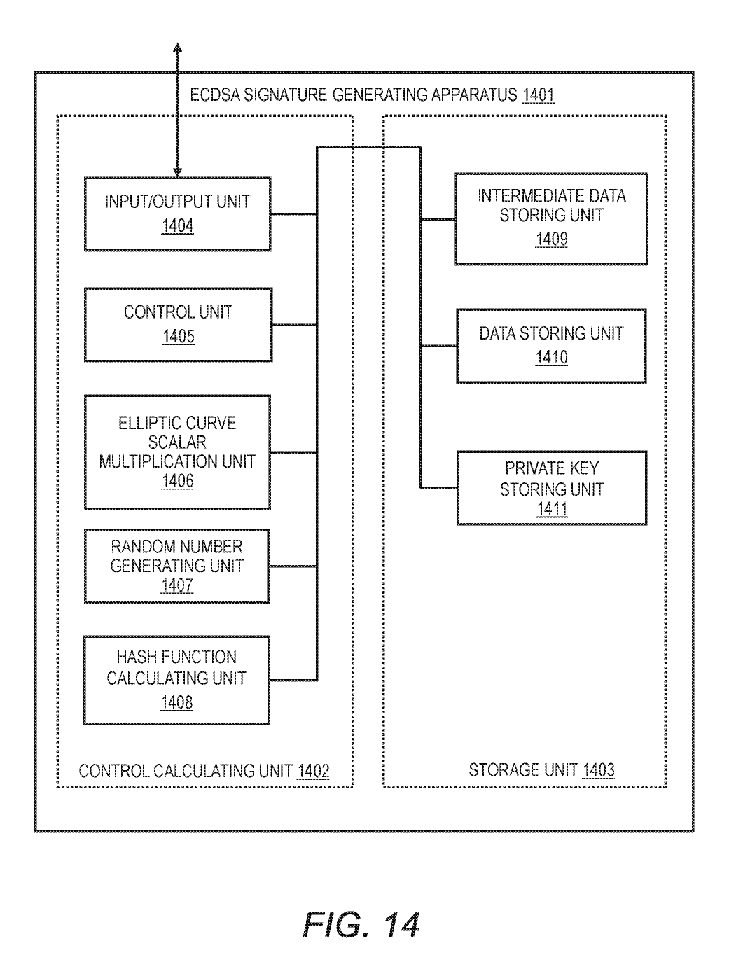

FIG. 14 is a diagram for illustrating a configuration example of an ECDSA signature generating apparatus 1401. The ECDSA signature generating apparatus 1401 includes a control calculating unit 1402 and a storage unit 1403. The control calculating unit 1402 includes an input/output unit 1404, a control unit 1405, an elliptic curve scalar multiplication unit 1406, a random number generating unit 1407, and a hash function calculating unit 1408. The ECDSA signature generating apparatus 1401 is built on, for example, the information processing apparatus 110 illustrated in FIG. 1B.

The input/output unit 1404 is configured to receive an input of, for example, a parameter of an elliptic curve, a field of definition, a base point and the order of the base point, a private key of a signer, and a plain text to be signed. The input/output unit 1404 is also configured to output a generated ECDSA signature. The control unit 1405 is configured to control the ECDSA signature generating apparatus 1401. The elliptic curve scalar multiplication unit 1406 is configured to calculate a scalar multiple of a base point. The random number generating unit 1407 is configured to generate a random number. The hash function calculating unit 1408 is configured to generate a hash value.

The storage unit 1403 includes an intermediate data storing unit 1409, a data storing unit 1410, and a private key storing unit 1411. The intermediate data storing unit 1409 is configured to store intermediate data generated during calculation that is made by the control calculating unit 1402. The data storing unit 1410 is configured to store, for example, a parameter of an elliptic curve, field-of-definition information, a base point, the order of the base point, and a plain text to be signed that are input via the input/output unit 1404, and a generated ECDSA signature. The private key storing unit 1411 is configured to store a private key of a signer that is input via the input/output unit 1404.

The flow of operation of the ECDSA signature generating apparatus 1401 is described next on the assumption that the operation of the ECDSA signature generating apparatus 1401 is controlled by the control unit 1405. The data storing unit 1410 stores, for example, the elliptic curve y²=x³+ax+b(4a²−27b³≠0, a,b∈ Fₚ), the field of definition Fₚ, the base point G of the elliptic curve, G=(x_{g},y_{g}), the order q (a prime number) of the base point G, and a plain text M to be signed that are input via the input/output unit 1404.

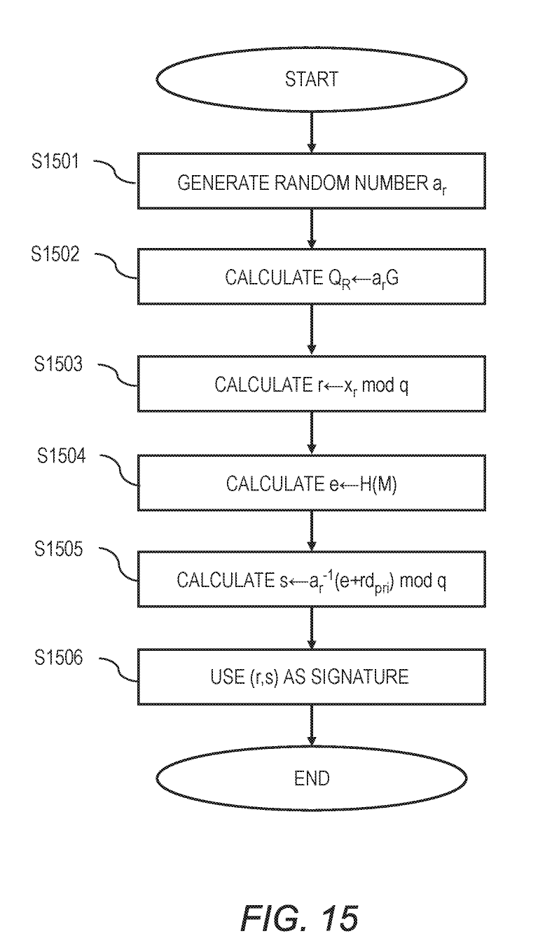

The private key storing unit 1411 stores the private key dₚᵣᵢ of the signer that is input via the input/output unit 1404. The control calculating unit 1402 uses information stored in the data storing unit 1410 and information stored in the private key storing unit 1411 to execute ECDSA signature generating processing and generate an ECDSA signature. The control calculating unit 1402 executes ECDSA signature processing by following, for example, a procedure that is described later with reference to FIG. 15. The data storing unit 1410 stores signature data generated by the control calculating unit 1402, the input/output unit 1404 outputs the signature data, and the processing is then ended.

FIG. 15 is a flow chart for illustrating an example of the ECDSA signature generating processing.

<Step S1501> The random number generating unit 1407 generates at random an integer aᵣ that satisfies 0<aᵣ<q.

<Step S1502> The elliptic curve scalar multiplication unit 1406 calculates Q_{R}←aᵣG=(xᵣ,yᵣ).

<Step S1503> A basic arithmetic function of the elliptic curve scalar multiplication unit 1406 calculates r←xᵣ mod q.

<Step S1504> The hash function calculating unit 1408 uses the hash function H to calculate e←H(M).

<Step S1505> The basic arithmetic function of the elliptic curve scalar multiplication unit 1406 calculates s←aᵣ⁻¹(e+rdₚᵣᵢ) mod q.

<Step S1506> The input/output unit 1404 outputs (r,s) as a signature.

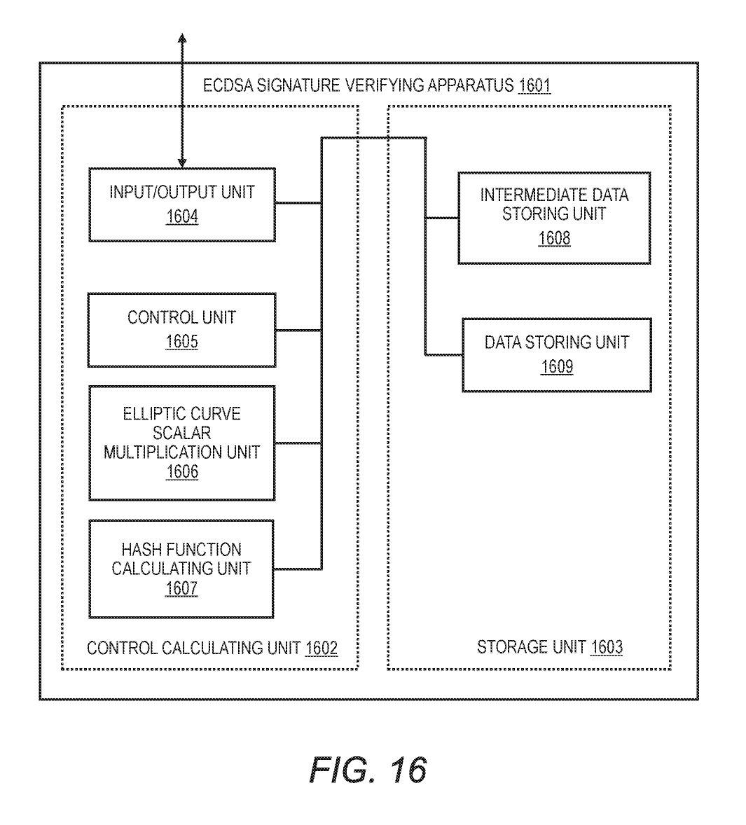

FIG. 16 is a diagram for illustrating a configuration example of an ECDSA signature verifying apparatus 1601. The ECDSA signature verifying apparatus 1601 includes a control calculating unit 1602 and a storage unit 1603. The control calculating unit 1602 includes an input/output unit 1604, a control unit 1605, an elliptic curve scalar multiplication unit 1606, and a hash function calculating unit 1607. The ECDSA signature verifying apparatus 1601 is built on, for example, the information processing apparatus 110 illustrated in FIG. 1B.

The input/output unit 1604 is configured to receive an input of, for example, a parameter of an elliptic curve, a field of definition, a base point, a public key of a signer, the order of the base point, a plain text to be signed, and a signature. The input/output unit 1604 is also configured to output a signature verification result. The control unit 1605 is configured to control the ECDSA signature verifying apparatus 1601. The elliptic curve scalar multiplication unit 1606 is configured to calculate scalar multiples of a base point and of a public key. The hash function calculating unit 1607 is configured to generate a hash value.

The storage unit 1603 includes an intermediate data storing unit 1608 and a data storing unit 1609. The intermediate data storing unit 1608 is configured to store intermediate data generated during calculation that is made by the control calculating unit 1602. The data storing unit 1609 is configured to store, for example, a parameter of an elliptic curve, field-of-definition information, a base point, a public key of a signer, the order of the base point and the public key, a signature verification target plain text, and a signature that are input via the input/output unit 1604, and a signature verification result.

The flow of operation of the ECDSA signature verifying apparatus 1601 is described next on the assumption that the operation of the ECDSA signature verifying apparatus 1601 is controlled by the control unit 1605. The data storing unit 1609 stores, for example, the elliptic curve y²=x³+ax+b(4a²−27b³≠0, a,b∈ Fₚ), the field of definition Fₚ, the base point G of the elliptic curve, G=(x_{g},y_{g}), the public key Q_{pub}=(x_{q},y_{q}), the order q (a prime number) of the base point G and the public key Q_{pub}, a plain text M, and a signature (r, s) of the plain text M that are input via the input/output unit 1604.

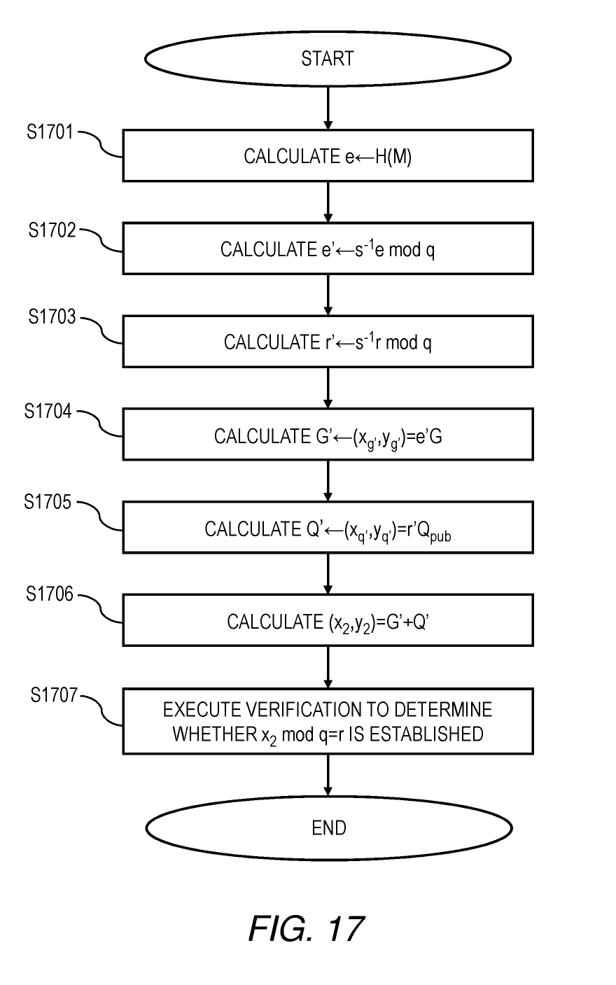

The control calculating unit 1602 uses information stored in the data storing unit 1609 to execute ECDSA signature verifying processing. The control calculating unit 1602 executes the ECDSA signature verifying processing by following, for example, a procedure that is described later with reference to FIG. 17. The data storing unit 1609 stores a signature verification result generated by the control calculating unit 1602, the input/output unit 1604 outputs the signature verification result, and the processing is then ended.

FIG. 17 is a flow chart for illustrating an example of the ECDSA signature verifying processing.

<Step S1701> The hash function calculating unit 1607 uses the hash function H to calculate e←H(M).

<Step S1702> A basic arithmetic function of the elliptic curve scalar multiplication unit 1606 calculates e′←s⁻¹e mod q.

<Step S1703> The basic arithmetic function of the elliptic curve scalar multiplication unit 1606 calculates r′←s⁻¹r mod q.

<Step S1704> The elliptic curve scalar multiplication unit 1606 calculates G′←(x_{g′},y_{g′})=e′G.

<Step S1705> The elliptic curve scalar multiplication unit 1606 calculates Q′←(x_{q′},y_{q′})=r′Q_{pub}.

<Step S1706> The basic arithmetic function of the elliptic curve scalar multiplication unit 1606 calculates (x₂,y₂)=G′+Q′.

<Step S1707> The basic arithmetic function of the elliptic curve scalar multiplication unit 1606 determines whether or not x₂ mod q=r is established. “True” is output as the verification result when it is determined that x₂ mod q=r is established, and “false” is output as the verification result when it is determined that x₂ mod q=r is not established.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The control lines and information lines given above are ones that are deemed necessary for description, and not all of control lines and information lines that are included in a product are listed. It can be considered that almost all components are actually coupled to one another.

1. An elliptic curve scalar multiplication method by which an elliptic curve scalar multiplication apparatus is configured to execute scalar multiplication of a first point on a first curve, which is a Weierstrass form elliptic curve,
the elliptic curve scalar multiplication apparatus being configured to store a prime number p and information of the first point, the prime number p defining a field of definition Fₚ, which defines the first curve, and being expressed as p=p₀+p₁c+ . . . +pₙcⁿ⁻¹, (where c equals 2^{f} and f is an integer equal to or larger than 1 that is units of breaking data into pieces in multiple-precision integer arithmetic executed by the elliptic curve scalar multiplication apparatus),
the elliptic curve scalar multiplication method comprising:
a first step of calculating, by the elliptic curve scalar multiplication apparatus, a Montgomery constant k₀, which is used for Montgomery multiplication of data x and data y, which are multiple-precision integers in units of f bits and expressed as x=x₀+x₁c+ . . . +xₙcⁿ⁻¹ and y=y₀+y₁c+ . . . +yₙcⁿ⁻¹ (c=2^{f}, f≧1, x<p, y<p, 1≦n), by the following processing (a1) through processing (a8):
(a1) determining whether or not p₀=2^{f}−1 is true, and proceeding to the processing (a2) when it is determined that p₀=2^{f}−1 is true, and to the processing (a3) when it is determined that p₀=2^{f}−1 is not true;
(a2) putting k₀←1, and proceeding to the processing (a8);
(a3) determining, for an integer that satisfies f/2≦g<f, whether or not p₀=2^{g}−1 is true, and proceeding to the processing (a4) when it is determined that p₀=2^{g}−1 is true, and to the processing (a5) when it is determined that p₀=2^{g}−1 is not true;
(a4) putting k₀←2^{g}+1, and proceeding to the processing (a8);
(a5) determining, for an integer that satisfies f/2≦g<f, whether or not p₀=2^{g}+1 is true, and proceeding to the processing (a6) when it is determined that p₀=2^{g}+1 is true, and to the processing (a7) when it is determined that p₀=2^{g}+1 is not true;
(a6) putting k₀←2^{g}−1, and proceeding to the processing (a8);
(a7) calculating k₀←−p⁻¹ mod 2^{f}, and proceeding to the processing (a8); and
(a8) using the k₀ as a calculation result;
a second step of calculating, by the elliptic curve scalar multiplication apparatus, work and h₁ by the following processing (b1) through processing (b11):
(b1) determining whether or not k₀=1 is true, and proceeding to the processing (b2) when it is determined that k₀=1 is true, and to the processing (b4) when it is determined that k₀=1 is not true;
(b2) putting work←l₀ (where l₀ is a least significant f bits value of x₀y₀;
(b3) putting h₁←work, and proceeding to the processing (b11);
(b4) calculating work←l₀k₀ mod c;
(b5) determining whether or not k₀=2^{g}+1 is true, and proceeding to the processing (b6) when it is determined that k₀=2^{g}+1 is true, and to the processing (b7) when it is determined that k₀=2^{g}+1 is not true;
(b6) calculating h₁←(work+(l₀>>g))>>(f−g);
(b7) determining whether or not k₀=2^{g}−1 is true, and proceeding to the processing (b8) when it is determined that k₀=2^{g}−1 is true, and to the processing (b10) when it is determined that k₀=2^{g}−1 is not true;
(b8) calculating h₁←(work+(l₀>>g))>>(f−g);
(b9) determining whether or not h₁≠0 is true, calculating h₁←h₁+1 and proceeding to the processing (b11) when it is determined that h₁≠0 is true, and proceeding to the processing (b11) without making the calculation when it is determined that h₁=0 is true;
(b10) calculating l₀+p₀work, putting most significant f bits of the calculated l₀+p₀work as h₁, and proceeding to the processing (b11); and
(b11) using the work and the h₁ as a calculation result;
a third step of executing, by the elliptic curve scalar multiplication apparatus, doubling of a second point, which is calculated from the first point, by Montgomery multiplication that uses the calculated Montgomery constant k₀, the calculated work, and the calculated h₁;
a fourth step of adding, by the elliptic curve scalar multiplication apparatus, a third point and a fourth point, which are calculated from the first point, by Montgomery multiplication that uses the calculated Montgomery constant k₀, the calculated work, and the calculated h₁; and
a fifth step of calculating, by the elliptic curve scalar multiplication apparatus, a scalar multiple of the first point, based on a result of the doubling of the second point and on a result of the addition of the third point and the fourth point.

2. The elliptic curve scalar multiplication method according to claim 1, wherein, in the Montgomery multiplication in the second step and the third step, the elliptic curve scalar multiplication apparatus is configured to execute Montgomery multiplication of the data x and the data y by the following processing (c1) through processing (c18):
(c1) putting z←0 and i←0;
(c2) determining whether or not i≦n is true, and proceeding to the processing (c3) when it is determined that i≦n is true, and to the processing (c12) when it is determined that i≦n is not true;
(c3) calculating z₀+x₀×yᵢ, putting least significant f bits as l₀, and putting most significant f bits as h₀;
(c4) calculating work and h₁ by the processing (b1) through the processing (b11);
(c5) putting j←1;
(c6) determining whether or not j≦n is true, and proceeding to the processing (c7) when it is determined that j≦n is true, and to the processing (c11) when it is determined that j≦n is not true;
(c7) calculating zⱼ+xⱼyᵢ+h₀, putting least significant f bits as l₀, and putting most significant f bits as h₀;
(c8) calculating l₀+pⱼwork+h₁, putting least significant f bits as l₁, and putting most significant f bits as h₁;
(c9) putting zⱼ₋₁←l₁;
(c10) putting j←j+1, and returning to the processing (c6);
(c11) putting i←i+1, and returning to the processing (c2);
(c12) calculating zₙ₊₁+h₀+h₁, putting least significant f bits as l, and putting most significant f bits as h;
(c13) putting zₙ←l;
(c14) calculating zₙ₊₁←zₙ₊₂+h;
(c15) putting zₙ₊₂←0;
(c16) putting z=z₀+z₁c+ . . . +zₙcⁿ⁻¹+zₙ₊₁cⁿ;
(c17) determining whether or not z≧p is true, calculating z←z−p when it is determined that z≧p is true, and skipping the calculation when it is determined that z≧p is not true; and
(c18) using the z as a calculation result.

3. The elliptic curve scalar multiplication method according to claim 2,
wherein the elliptic curve scalar multiplication apparatus is further configured to store a parameter a of the first curve, y²=x³+ax+b(4a²−27b³≠0, a,b∈ Fp),
wherein, in the third step, the elliptic curve scalar multiplication apparatus is configured to execute doubling of the second point, Q_{Jm}=(X₁ₘ:Y₁ₘ:Z₁ₘ), by the following processing (d1) through processing (d8):
(d1) calculating S←4X₁ₘY₁ₘ²;
(d2) determining whether or not a=−3 is true, and proceeding to the processing (d3) when it is determined that a=−3 is true, and to the processing (d4) when it is determined that a=−3 is not true;
(d3) calculating H←Z₁ₘ² and M←3(X₁ₘ+H)(X₁ₘ−H), and proceeding to the processing (d5);
(d4) calculating M←3X₁ₘ²+aZ₁ₘ², and proceeding to the processing (d5);
(d5) calculating X₃ₘ←M²−2S;
(d6) calculating Y₃ₘ←M(S−X₃ₘ)−8Y₁ₘ⁴;
(d7) calculating Z₃ₘ←2Y₁ₘZ₁ₘ; and
(d8) using Q_{Jm}←(X₃ₘ:Y₃ₘ:Z₃ₘ) as a calculation result, and
wherein Montgomery multiplication in the processing (d1) and the processing (d3) through the processing (d7) is executed by using the processing (c1) through the processing (c18).

4. The elliptic curve scalar multiplication method according to claim 2,
wherein, in the fourth step, the elliptic curve scalar multiplication apparatus is configured to add the third point, P_{Jm}=(X₁ₘ:Y₁ₘ:Z₁ₘ), and the fourth point, Q_{Jm}=(X₂ₘ:Y₂ₘ:Z₂ₘ), by the following processing (e1) through processing (e7):
(e1) calculating U₁←X₁ₘZ₂ₘ² and U₂←X₂ₘZ₁ₘ²;
(e2) calculating S₁←Y₁ₘZ₂ₘ³ and S₂←Y₂ₘZ₁ₘ³;
(e3) calculating H←U₂−U₁ and V←S₂−S₁;
(e4) calculating X₃ₘ←V²−H³−2U₁H²;
(e5) calculating Y₃ₘ←V(U₁H²−X₃ₘ)−S₁H³;
(e6) calculating Z₃ₘ←HZ₁ₘZ₂ₘ; and
(e7) using Q_{Jm}←(X₃ₘ:Y₃ₘ:Z₃ₘ) as a calculation result, and
wherein Montgomery multiplication in the processing (e1) through the processing (e7) is executed by using the processing (c1) through the processing (c18).

5. The elliptic curve scalar multiplication method according to claim 3,
wherein the elliptic curve scalar multiplication apparatus is further configured to store R=2^{fk} defined by a minimum integer k that satisfies p<2^{fk},
the elliptic curve scalar multiplication method further comprising calculating, by the elliptic curve scalar multiplication apparatus, a scalar multiple of the first point P=(x₁,y₁) by the following processing (f1) through processing (f9):
(f1) calculating the Montgomery constant k₀ by the processing (a1) through the processing (a8);
(f2) calculating a point P_{Jm}=(X₁ₘ:Y₁ₘ:Z₁ₘ)←(x₁R mod p:y₁R mod p:R mod p) by conversion from the first point P=(x₁,y₁), and calculating aₘ←aR mod p for the parameter a of the first curve y²=x³+ax+b;
(f3) putting i←t−2 and Q_{Jm}←P_{Jm};
(f4) calculating Q_{Jm}←2Q_{Jm} by the processing (d1) through the processing (d8);
(f5) determining whether or not lᵢ=1 is true, and proceeding to the processing (f6) when it is determined that lᵢ=1 is true, and to the processing (f7) when it is determined that lᵢ=1 is not true;
(f6) calculating Q_{Jm}←Q_{Jm}+P_{Jm};
(f7) calculating i←i−1;
(f8) determining whether or not i≧0 is true, returning to the processing (f4) when i≧0 is true, and proceeding to the processing (f9) when i≧0 is not true;
(f9) converting Q_{Jm} into Q_{J} by calculating Q_{J}=(X₃:Y₃:Z₃)←(X₃ₘR⁻¹ mod p:Y₃ₘR⁻¹ mod p:Z₃ₘR⁻¹ mod p); and
(f10) calculating Q=(x₃, y₃)←(X₃/Z₃²,Y₃/Z₃³) from the scalar multiplication result Q_{J}=(X₃:Y₃:Z₃), and using the Q as a calculation result,
wherein, in the processing (f6), the third point, P_{Jm}=(X₁ₘ:Y₁ₘ:Z₁ₘ), and the fourth point, Q_{Jm}=(X₂ₘ:Y₂ₘ:Z₂ₘ), are added by the following processing (e1) through processing (e7):
(e1) calculating U₁←X₁ₘZ₂ₘ² and U₂←X₂ₘZ₁ₘ²;
(e2) calculating S₁←Y₁ₘZ₂ₘ³ and S₂←Y₂ₘZ₁ₘ³;
(e3) calculating H←U₂−U₁ and V←S₂−S₁;
(e4) calculating X₃ₘ←V²−H³−2U₁H²;
(e5) calculating Y₃ₘ←V(U₁H²−X₃ₘ)−S₁H³;
(e6) calculating Z₃ₘ←HZ₁ₘZ₂ₘ; and
(e7) using Q_{Jm}←(X₃ₘ:Y₃ₘ:Z₃ₘ) as a calculation result, and
wherein Montgomery multiplication in the processing (e1) through the processing (e7) is executed by using the processing (c1) through the processing (c18).

6. An ECDSA key pair generating method, which is executed by an ECDSA key pair generating apparatus comprising the elliptic curve scalar multiplication apparatus using the elliptic curve scalar multiplication method of claim 5,
the ECDSA key pair generating apparatus being configured to store a base point G on the first curve and an order q of the base point G,
the ECDSA key pair generating method comprising generating, by the ECDSA key pair generating apparatus, an ECDSA key pair by the following processing (g1) through processing (g3):
(g1) generating at random an integer dₚᵣᵢ that satisfies 0<dₚᵣᵢ<q, and using the integer dₚᵣᵢ as a private key;
(g2) in the processing (f1) through the processing (f10), putting the base point G as the first point, using a scalar multiple Q_{pub}←dₚᵣᵢG=(x,y) of the base point G in calculation, and using a result Q_{pub} of the calculation as a public key; and
(g3) using (dₚᵣᵢ,Q_{pub}) as an ECDSA key pair.

7. An ECDSA signature generating method, which is executed by an ECDSA signature generating apparatus comprising the elliptic curve scalar multiplication apparatus using a private key generated by the ECDSA key pair generating method of claim 6,
the ECDSA signature generating apparatus being configured to store the base point G, the order q, the generated private key dₚᵣᵢ, and a plain text M to be signed,
the ECDSA signature generating method comprising generating, by the ECDSA signature generating apparatus, an ECDSA signature by the following processing (h1) through processing (h6):
(h1) generating at random an integer aᵣ that satisfies 0<aᵣ<q;
(h2) in the processing (f1) through the processing (f10), putting the base point G as the first point and calculating a scalar multiple Q_{R}←aᵣG=(xᵣ,yᵣ) of the base point G;
(h3) calculating r←xᵣ mod q;
(h4) calculating a hash function e←H(M) of the plain text M to be signed;
(h5) calculating s←aᵣ⁻¹(e+rdₚᵣᵢ) mod q; and
(h6) using (r,s) as a signature.

8. A method of verifying an ECDSA signature that is generated by the ECDSA signature generating method of claim 7, which is executed by an ECDSA signature verifying apparatus comprising the elliptic curve scalar multiplication apparatus,
the ECDSA signature verifying apparatus being configured to store the base point G, the order q, the public key Q_{pub}=(x_{Q},Y_{Q}), a signature verification target plain text M, and the signature (r, s),
the method comprising executing, by the ECDSA signature verifying apparatus, verification of the ECDSA signature by the following processing (i1) through processing (i7):
(i1) calculating a hash value e←H(M) of the signature verification target plain text M;
(i2) calculating e′←s⁻¹e mod q;
(i3) calculating r′←s⁻¹r mod q;
(i4) in the processing (f1) through the processing (f10), putting the base point G as the first point and calculating a scalar multiple G′←(x_{g′},y_{g′})=e′G of the base point G;
(i5) in the processing (f1) through the processing (f10), putting the public key Q_{pub} as the first point and calculating a scalar multiple Q′←(x_{q′},y_{q′})=r′Q_{pub} of the public key Q_{pub};
(i6) calculating (x₂,y₂)=G′+Q′; and
(i7) determining whether or not x₂ mod q=r is established, using “true” as a verification result when it is determined that x₂ mod q=r is established, and using “false” as a verification result when it is determined that x₂ mod q=r is not established.

9. A computer-readable non-transitory recording medium having stored thereon a program for causing an elliptic curve scalar multiplication apparatus to execute scalar multiplication of a first point on a first curve, which is a Weierstrass form elliptic curve,
the elliptic curve scalar multiplication apparatus being configured to store a prime number p and information of the first point, the prime number p defining a field of definition Fₚ, which defines the first curve, and being expressed as p=p₀+p₁c+ . . . +pₙcⁿ⁻¹, (where c equals 2^{f} and f is an integer equal to or larger than 1 that is units of breaking data into pieces in multiple-precision integer arithmetic executed by the elliptic curve scalar multiplication apparatus),
the program causing the elliptic curve scalar multiplication apparatus to execute:
a first procedure of calculating a Montgomery constant k₀, which is used for Montgomery multiplication of data x and data y, which are multiple-precision integers in units of f bits and expressed as x=x₀+x₁c+ . . . +xₙcⁿ⁻¹ and y=y₀+y₁c+ . . . +yₙcⁿ⁻¹ (c=2^{f}, x<p, y<p, 1≦n), by the following processing (a1) through processing (a8):
(a1) determining whether or not p₀=2^{f}−1 is true, and proceeding to the processing (a2) when it is determined that p₀=2^{f}−1 is true, and to the processing (a3) when it is determined that p₀=2^{f}−1 is not true;
(a2) putting k₀←1, and proceeding to the processing (a8);
(a3) determining, for an integer that satisfies f/2≦g<f, whether or not p₀=2^{g}−1 is true, and proceeding to the processing (a4) when it is determined that p₀=2^{g}−1 is true, and to the processing (a5) when it is determined that p₀=2^{g}−1 is not true;
(a4) putting k₀←2^{g}+1, and proceeding to the processing (a8);
(a5) determining, for an integer that satisfies f/2≦g<f, whether or not p₀=2^{g}+1 is true, and proceeding to the processing (a6) when it is determined that p₀=2^{g}+1 is true, and to the processing (a7) when it is determined that p₀=2^{g}+1 is not true;
(a6) putting k₀←2^{g}−1, and proceeding to the processing (a8);
(a7) calculating k₀←−p⁻¹ mod 2^{f}, and proceeding to the processing (a8); and
(a8) using the k₀ as a calculation result;
a second procedure of calculating work and h₁ by the following processing (b1) through processing (b11):
(b1) determining whether or not k₀=1 is true, and proceeding to the processing (b2) when it is determined that k₀=1 is true, and to the processing (b4) when it is determined that k₀=1 is not true;
(b2) putting work←l₀ (where l₀ is a least significant f bits value of x₀y₀);
(b3) putting h₁←work, and proceeding to the processing (b11);
(b4) calculating work←l₀k₀ mod c;
(b5) determining whether or not k₀=2^{g}+1 is true, and proceeding to the processing (b6) when it is determined that k₀=2^{g}+1 is true, and to the processing (b7) when it is determined that k₀=2^{g}+1 is not true;
(b6) calculating h₁←(work+(l₀>>g))>>(f−g);
(b7) determining whether or not k₀=2^{g}−1 is true, and proceeding to the processing (b8) when it is determined that k₀=2^{g}−1 is true, and to the processing (b10) when it is determined that k₀=2^{g}−1 is not true;
(b8) calculating h₁←(work+(l₀>>g))>>(f−g);
(b9) determining whether or not h₁≠0 is true, calculating h₁←h₁+1 and proceeding to the processing (b11) when it is determined that h₁≠0 is true, and proceeding to the processing (b11) without making the calculation when it is determined that h₁=0 is true;
(b10) calculating l₀+p₀work, putting most significant f bits of the calculated l₀+p₀work as h₁, and proceeding to the processing (b11); and
(b11) using the work and the h₁ as a calculation result;
a third procedure of executing doubling of a second point, which is calculated from the first point, by Montgomery multiplication that uses the calculated Montgomery constant k₀, the calculated work, and the calculated h₁;
a fourth procedure of adding a third point and a fourth point, which are calculated from the first point, by Montgomery multiplication that uses the calculated Montgomery constant k₀, the calculated work, and the calculated h₁; and
a fifth procedure of calculating a scalar multiple of the first point, based on a result of the doubling of the second point and on a result of the addition of the third point and the fourth point.

10. The computer-readable non-transitory recording medium according to claim 9, wherein, in the Montgomery multiplication in the second procedure and the third procedure, the program causes the elliptic curve scalar multiplication apparatus to execute Montgomery multiplication of the data x and the data y by the following processing (c1) through processing (c18):
(c1) putting z←0 and i←0;
(c2) determining whether or not i≦n is true, and proceeding to the processing (c3) when it is determined that i≦n is true, and to the processing (c12) when it is determined that i≦n is not true;
(c3) calculating z₀+x₀×yᵢ, putting least significant f bits as l₀, and putting most significant f bits as h₀;
(c4) calculating work and h₁ by the processing (b1) through the processing (b11);
(c5) putting j←1;
(c6) determining whether or not j≦n is true, and proceeding to the processing (c7) when it is determined that j≦n is true, and to the processing (c11) when it is determined that j≦n is not true;
(c7) calculating zⱼ+xⱼyᵢ+h₀, putting least significant f bits as l₀, and putting most significant f bits as h₀;
(c8) calculating l₀+pⱼwork+h₁, putting least significant f bits as l₁, and putting most significant f bits as h₁;
(c9) putting zⱼ₋₁←l₁;
(c10) putting j←j+1, and returning to the processing (c6);
(c11) putting i←i+1, and returning to the processing (c2);
(c12) calculating zₙ₊₁+h₀+h₁, putting least significant f bits as l, and putting most significant f bits as h;
(c13) putting zₙ←l;
(c14) calculating zₙ₊₁←zₙ₊₂+h;
(c15) putting zₙ₊₂←0;
(c16) putting z=z₀+z₁c+ . . . +zₙcⁿ⁻¹+zₙ₊₁cⁿ;
(c17) determining whether or not z≧p is true, calculating z←z−p when it is determined that z≧p is true, and skipping the calculation when it is determined that z≧p is not true; and
(c18) using the z as a calculation result.

11. The computer-readable non-transitory recording medium according to claim 10,
wherein the elliptic curve scalar multiplication apparatus is further configured to store a parameter a of the first curve, y²=x³+ax+b(4a²−27b³≠0, a,b∈ Fp),
wherein, in the third procedure, the program causes the elliptic curve scalar multiplication apparatus to execute doubling of the second point, Q_{Jm}=(X₁ₘ:Y₁ₘ:Z₁ₘ), by the following processing (d1) through processing (d8):
(d1) calculating S←4X₁ₘY₁ₘ²;
(d2) determining whether or not a=−3 is true, and proceeding to the processing (d3) when it is determined that a=−3 is true, and to the processing (d4) when it is determined that a=−3 is not true;
(d3) calculating H←Z₁ₘ² and M←3(X₁ₘ+H)(X₁ₘ−H), and proceeding to the processing (d5);
(d4) calculating M←3X₁ₘ²+aZ₁ₘ², and proceeding to the processing (d5);
(d5) calculating X₃ₘ←M²−2S;
(d6) calculating Y₃ₘ←M(S−X₃ₘ)−8Y₁ₘ⁴;
(d7) calculating Z₃ₘ←2Y₁ₘZ₁ₘ; and
(d8) using Q_{Jm}←(X₃ₘ:Y₃ₘ:Z₃ₘ) as a calculation result, and
wherein the program causes the elliptic curve scalar multiplication apparatus to execute Montgomery multiplication in the processing (d1) and the processing (d3) through the processing (d7) by using the processing (c1) through the processing (c18).

12. The computer-readable non-transitory recording medium according to claim 10,
wherein, in the fourth procedure, the program causes the elliptic curve scalar multiplication apparatus to execute addition of the third point, P_{Jm}=(X₁ₘ:Y₁ₘ:Z₁ₘ), and the fourth point, Q_{Jm}=(X₂ₘ:Y₂ₘ:Z₂ₘ), by the following processing (e1) through processing (e7):
(e1) calculating U₁←X₁ₘZ₂ₘ² and U₂←X₂ₘZ₁ₘ²;
(e2) calculating S₁←Y₁ₘZ₂ₘ³ and S₂←Y₂ₘZ₁ₘ³;
(e3) calculating H←U₂−U₁ and V←S₂−S₁;
(e4) calculating X₃ₘ←V²−H³−2U₁H²;
(e5) calculating Y₃ₘ←V(U ₁ H²−X₃ₘ)−S₁H³;
(e6) calculating Z₃ₘ←HZ₁ₘZ₂ₘ; and
(e7) using Q_{Jm}←(X₃ₘ:Y₃ₘ:Z₃ₘ) as a calculation result, and
wherein the program causes the elliptic curve scalar multiplication apparatus to execute Montgomery multiplication in the processing (e1) through the processing (e7) by using the processing (c1) through the processing (c18).

13. The computer-readable non-transitory recording medium according to claim 11,
wherein the elliptic curve scalar multiplication apparatus is configured to further store R=2^{fk} defined by a minimum integer k that satisfies p<2^{fk},
wherein the program causes the elliptic curve scalar multiplication apparatus to calculate a scalar multiple of the first point by the following processing (f1) through processing (f9):
(f1) calculating the Montgomery constant k₀ by the processing (a1) through the processing (a8);
(f2) calculating a point P_{Jm}=(X₁ₘ:Y₁ₘ:Z₁ₘ)←(x₁R mod p:y₁R mod p:R mod p) by conversion from the first point, P=(x₁,y₁), and calculating aₘ←aR mod p for the parameter a of the first curve y²=x³+ax+b;
(f3) putting i←t−2 and Q_{Jm}←P_{Jm};
(f4) calculating Q_{Jm}←2Q_{Jm} by the processing (d1) through the processing (d8);
(f5) determining whether or not lᵢ=1 is true, and proceeding to the processing (f6) when it is determined that lᵢ=1 is true, and to the processing (f7) when it is determined that lᵢ=1 is not true;
(f6) calculating Q_{Jm}←Q_{Jm}+P_{Jm};
(f7) calculating i←i−1;
(f8) determining whether or not i≧0 is true, returning to the processing (f4) when i≧0 is true, and proceeding to the processing (f9) when i≧0 is not true;
(f9) converting Q_{Jm} into Q_{J} by calculating Q_{J}=(X₃:Y₃:Z₃)←(X₃ₘR⁻¹ mod p:Y₃ₘR⁻¹ mod p:Z₃ₘR⁻¹ mod p); and
(f10) calculating Q=(x₃, y₃)←(X₃/Z₃²,Y₃/Z₃³) from the scalar multiplication result Q_{J}=(X₃:Y₃:Z₃), and using the Q as a calculation result,
wherein, in the processing (f6), the program causes the elliptic curve scalar multiplication apparatus to execute addition of the third point, P_{Jm}=(X₁ₘ:Y₁ₘ:Z₁ₘ), and the fourth point, Q_{Jm}=(X₂ₘ:Y₂ₘ:Z₂ₘ), by the following processing (e1) through processing (e7):
(e1) calculating U₁←X₁ₘZ₂ₘ² and U₂←X₂ₘZ₁ₘ²;
(e2) calculating S₁←Y₁ₘZ₂ₘ³ and S₂←Y₂ₘZ₁ₘ³;
(e3) calculating H←U₂−U₁ and V←S₂−S₁;
(e4) calculating X₃ₘ←V²−H³−2U₁H²;
(e5) calculating Y₃ₘ←V(U₁H²−X₃ₘ)−S₁H³;
(e6) calculating Z₃ₘ←HZ₁ₘZ₂ₘ; and
(e7) using Q_{Jm}←(X₃ₘ:Y₃ₘ:Z₃ₘ) as a calculation result, and
wherein the program causes the elliptic curve scalar multiplication apparatus to execute Montgomery multiplication in the processing (e1) through the processing (e7) by using the processing (c1) through the processing (c18).

14. The computer-readable non-transitory recording medium according to claim 13,
wherein the program causes an ECDSA key pair generating apparatus comprising the elliptic curve scalar multiplication apparatus to generate an ECDSA key pair,
wherein the ECDSA key pair generating apparatus is configured to store a base point G on the first curve and an order q of the base point G, and
wherein the program causes the ECDSA key pair generating apparatus to generate an ECDSA key pair by the following processing (g1) through processing (g3):
(g1) generating at random an integer dₚᵣᵢ that satisfies 0<dₚᵣᵢ<q, and using the integer dₚᵣᵢ as a private key;
(g2) in the processing (f1) through the processing (f10), putting the base point G as the first point, using a scalar multiple Q_{pub}←dₚᵣᵢG=(x,y) of the base point G in calculation, and using a result Q_{pub} of the calculation as a public key; and
(g3) using (dₚᵣᵢ,Q_{pub}) as an ECDSA key pair.

15. An elliptic curve scalar multiplication apparatus for calculating a scalar multiple of a first point on a first curve, which is a Weierstrass form elliptic curve, the elliptic curve scalar multiplication apparatus comprising:
an elliptic curve addition unit configured to add points on the first curve;
an elliptic curve doubling unit configured to execute doubling of a point on the first curve; and
a basic arithmetic unit configured to execute arithmetic on a field of definition of the first curve, four arithmetic operations that use modulo operation, and Montgomery arithmetic,
wherein the elliptic curve scalar multiplication apparatus is configured to store a prime number p and information of the first point, the prime number p defining a field of definition Fₚ, which defines the first curve, and being expressed as p=p₀+p₁c+ . . . +pₙcⁿ⁻¹, (where c equals 2^{f} and f is an integer equal to or larger than 1 that is units of breaking data into pieces in multiple-precision integer arithmetic executed by the elliptic curve scalar multiplication apparatus),
wherein the basic arithmetic unit is configured to:
calculate a Montgomery constant k₀, which is used for Montgomery multiplication of data x and data y, which are multiple-precision integers in units of f bits and expressed as x=x₀+x₁c+ . . . +xₙcⁿ⁻¹ and y=y₀+y₁c+ . . . +yₙcⁿ⁻¹ (c=2^{f}, f≧1, x<p, y<p, 1−n), by the following processing (a1) through processing (a8):
(a1) determining whether or not p₀=2^{f}−1 is true, and proceeding to the processing (a2) when it is determined that p₀=2^{f}−1 is true, and to the processing (a3) when it is determined that p₀=2^{f}−1 is not true;
(a2) putting k₀←1, and proceeding to the processing (a8);
(a3) determining, for an integer that satisfies f/2≦g<f, whether or not p₀=2^{g}−1 is true, and proceeding to the processing (a4) when it is determined that p₀=2^{g}−1 is true, and to the processing (a5) when it is determined that p₀=2^{g}−1 is not true;
(a4) putting k₀←2^{g}+1, and proceeding to the processing (a8);
(a5) determining, for an integer that satisfies f/2≦g<f, whether or not p₀=2^{g}+1 is true, and proceeding to the processing (a6) when it is determined that p₀=2^{g}+1 is true, and to the processing (a7) when it is determined that p₀=2^{g}+1 is not true;
(a6) putting k₀←2^{g}−1, and proceeding to the processing (a8);
(a7) calculating k₀←−p⁻¹ mod 2^{f}, and proceeding to the processing (a8); and
(a8) using the k₀ as a calculation result; and
calculate work and h₁ by the following processing (b1) through processing (b11):
(b1) determining whether or not k₀=1 is true, and proceeding to the processing (b2) when it is determined that k₀=1 is true, and to the processing (b4) when it is determined that k₀=1 is not true;
(b2) putting work←l₀ (where lₒ is a least significant f bits value of x₀y₀);
(b3) putting h₁←work, and proceeding to the processing (b11);
(b4) calculating work←l₀k₀ mod c;
(b5) determining whether or not k₀=2^{g}+1 is true, and proceeding to the processing (b6) when it is determined that k₀=2^{g}+1 is true, and to the processing (b7) when it is determined that k₀=2^{g}+1 is not true;
(b6) calculating h₁←(work+(l₀>>g))>>(f−g);
(b7) determining whether or not k₀=2^{g}−1 is true, and proceeding to the processing (b8) when it is determined that k₀=2^{g}−1 is true, and to the processing (b10) when it is determined that k₀=2^{g}−1 is not true;
(b8) calculating h₁←(work+(l₀>>g))>>(f−g);
(b9) determining whether or not h₁≠0 is true, calculating h₁←h₁+1 and proceeding to the processing (b11) when it is determined that h₁≠0 is true, and proceeding to the processing (b11) without making the calculation when it is determined that h₁=0 is true;
(b10) calculating l₀+p₀work, putting most significant f bits of the calculated l₀+p₀work as h₁, and proceeding to the processing (b11); and
(b11) using the work and the h₁ as a calculation result,
wherein the elliptic curve doubling unit is configured to execute doubling of a second point, which is calculated from the first point, by Montgomery multiplication that uses the calculated Montgomery constant k₀, the calculated work, and the calculated h₁,
wherein the elliptic curve addition unit is configured to add a third point and a fourth point, which are calculated from the first point, by Montgomery multiplication that uses the calculated Montgomery constant k₀, the calculated work, and the calculated h₁, and
wherein the basic arithmetic unit is configured to calculate a scalar multiple of the first point, based on a result of the doubling of the second point and on a result of the addition of the third point and the fourth point.
